(19) United States
(12) Patent Application Publication
(10) Pub. No.: US 2024/0323878 A1
(43) Pub. Date: Sep. 26, 2024

(54) TIMING MODIFICATIONS FOR DEVICES BASED ON OPERATIONAL STATES

(71) Applicant: QUALCOMM Incorporated, San Diego, CA (US)

(72) Inventors: Ahmed Elshafie, San Diego, CA (US); Linhai He, San Diego, CA (US); Diana Maamari, San Diego, CA (US); Huilin Xu, Temecula, CA (US)

(21) Appl. No.: 18/186,834

(22) Filed: Mar. 20, 2023

(51) Int. Cl. H04W 56/00

(52) U.S. Cl. CPC H04W 56/0045

(57) ABSTRACT

Methods, systems, and devices for wireless communications are described. In some systems, a network node (e.g., a user equipment (UE)) may operate according to an operational state during which the network node is unavailable for communicating information. The network node may modify timing to account for the operational state. For example, a first network node (e.g., a UE) may receive, from a second network node (e.g., a network entity or base station), timing information corresponding to a timer. If a duration of the timer at least partially overlaps in time with a duration of the operational state for the first network node, the first network node may modify at least one of the timing information or the duration of the operational state. The first network node may communicate with the second network node in accordance with the modified timing information or the modified duration of the operational state.

### INTRODUCTION

The following relates to wireless communications including timing modifications for network nodes.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support timing modifications for devices based on operational states. For example, the described techniques provide for improved coordination between timers and operational states (e.g., energy harvesting states, low power states). A network node (e.g., a user equipment (UE)) may operate according to an operational state during which the network node is unavailable for communicating information. The network node may modify timing to account for the operational state. For example, a first network node (e.g., a UE) may receive, from a second network node (e.g., a network entity or base station), timing information corresponding to a timer. If an active duration of the timer at least partially overlaps in time with an active duration of the operational state for the first network node, the first network node may modify at least one of the timing information or the duration of the operational state. In some cases, the first network node may modify a duration of the timer, cancel the timer, pause the timer, modify the duration of the operational state, cancel the operational state, or any combination thereof based on the overlap. The first network node may communicate with the second network node in accordance with the modified timing information or the modified duration of the operational state. The first network node and the second network node may perform similar timing modifications to support coordination and timing alignment between the first network node (e.g., a UE) and the second network node (e.g., a network entity).

A method of wireless communications performed by a first network node is described. The method may include receiving, from a second network node, timing information corresponding to a timer, modifying, based on an overlap in time of a duration of the timer and a duration of an operational state for the first network node, at least one of the timing information or the duration of the operational state, and communicating with the second network node in accordance with the modified timing information or the modified duration of the operational state.

A first network node for wireless communication is described. The first network node may include a memory and at least one processor coupled to the memory. The at least one processor may be configured to receive, from a second network node, timing information corresponding to a timer, modify, based on an overlap in time of a duration of the timer and a duration of an operational state for the first network node, at least one of the timing information or the duration of the operational state, and communicate with the second network node in accordance with the modified timing information or the modified duration of the operational state.

An apparatus for wireless communications at a first network node is described. The apparatus may include means for receiving, from a second network node, timing information corresponding to a timer, means for modifying, based on an overlap in time of a duration of the timer and a duration of an operational state for the first network node, at least one of the timing information or the duration of the operational state, and means for communicating with the second network node in accordance with the modified timing information or the modified duration of the operational state.

A non-transitory computer-readable medium having code for wireless communication stored thereon is described. The code, when executed by a first network node, may cause the first network node to receive, from a second network node, timing information corresponding to a timer, modify, based on an overlap in time of a duration of the timer and a duration of an operational state for the first network node, at least one of the timing information or the duration of the operational state, and communicate with the second network node in accordance with the modified timing information or the modified duration of the operational state.

Some aspects of the method, first network node, apparatus, and non-transitory computer-readable medium described herein may further include operations, features, means, code, or instructions for: increasing, based on the modified timing information, the duration of the timer; decreasing, based on the modified timing information, the duration of the timer; canceling, based on the modified timing information, the duration of the timer; or pausing, based on the modified timing information, the timer.

In some aspects of the method, first network node, apparatus, and non-transitory computer-readable medium described herein, the timer includes a bandwidth part (BWP) inactivity timer, a BWP switching delay timer, a search space set group (SSSG) switching timer, a secondary cell (SCell) deactivation timer, a discontinuous reception (DRX) inactivity timer, a short DRX timer, or a long DRX timer.

In some aspects of the method, first network node, apparatus, and non-transitory computer-readable medium described herein, modifying the duration of the operational state may include operations, features, means, code, or instructions for decreasing the duration of the operational state for the first network node.

In some aspects of the method, first network node, apparatus, and non-transitory computer-readable medium described herein, modifying the duration of the operational state may include operations, features, means, code, or instructions for canceling the duration of the operational state for the first network node.

Some aspects of the method, first network node, apparatus, and non-transitory computer-readable medium described herein may further include operations, features, means, code, or instructions for receiving, from the second network node, a signal that indicates to cancel the duration of the operational state for the first network node based on the overlap in time of the duration of the timer and the duration of the operational state for the first network node, where the duration of the operational state for the first network node may be canceled further based on the signal.

Some aspects of the method, first network node, apparatus, and non-transitory computer-readable medium described herein may further include operations, features, means, code, or instructions for receiving, from the second network node, a signal that configures a first delta value for the first network node, where modifying at least one of the timing information or the duration of the operational state includes modifying the duration of the timer or the duration of the operational state based on the first delta value.

In some aspects of the method, first network node, apparatus, and non-transitory computer-readable medium described herein, the signal configures a set of multiple delta values including at least the first delta value. Some aspects of the method, first network node, apparatus, and non-transitory computer-readable medium described herein may further include operations, features, means, code, or instructions for selecting the first delta value from the set of multiple delta values based on the operational state for the first network node, where the operational state for the first network node may be based on the duration of the operational state including an energy harvesting duration for the first network node, based on an energy availability for radio frequency (RF) tuning for the first network node, or both.

In some aspects of the method, first network node, apparatus, and non-transitory computer-readable medium described herein, the signal includes downlink control information (DCI), a medium access control element (MAC-CE), a radio resource control (RRC) signal, or a wake-up signal.

Some aspects of the method, first network node, apparatus, and non-transitory computer-readable medium described herein may further include operations, features, means, code, or instructions for transmitting, to the second network node, a wake-up signal response that includes a request for a second delta value for the first network node, where the signal that configures the first delta value may be received based on the request.

Some aspects of the method, first network node, apparatus, and non-transitory computer-readable medium described herein may further include operations, features, means, code, or instructions for performing an energy harvesting procedure during at least a portion of the modified duration of the operational state.

In some aspects of the method, first network node, apparatus, and non-transitory computer-readable medium described herein, the modified duration of the operational state includes a first portion during which a first switch from a communication mode to an energy harvesting mode may be configured to occur, a second portion during which the energy harvesting procedure may be configured to occur, and a third portion during which a second switch from the energy harvesting mode to the communication mode may be configured to occur, where the portion of the modified duration of the operational state includes the second portion.

Some aspects of the method, first network node, apparatus, and non-transitory computer-readable medium described herein may further include operations, features, means, code, or instructions for performing first RF tuning from a first frequency band for communication to a second frequency band for the energy harvesting procedure and performing second RF tuning from the second frequency band for the energy harvesting procedure to the first frequency band for the communication, where the modified duration of the operational state for the first network node further includes the first RF tuning and the second RF tuning.

In some aspects of the method, first network node, apparatus, and non-transitory computer-readable medium described herein, modifying at least one of the timing information or the duration of the operational state may include operations, features, means, code, or instructions for modifying at least one of the timing information or the duration of the operational state based on a type of the energy harvesting procedure, where the type of the energy harvesting procedure includes RF energy harvesting, solar energy harvesting, thermal energy harvesting, vibrational energy harvesting, or laser energy harvesting.

In some aspects of the method, first network node, apparatus, and non-transitory computer-readable medium described herein, modifying at least one of the timing information or the duration of the operational state may include operations, features, means, code, or instructions for modifying at least one of the timing information or the duration of the operational state based on a capability of the first network node to perform an RF tuning procedure to a new BWP concurrent to the energy harvesting procedure.

Some aspects of the method, first network node, apparatus, and non-transitory computer-readable medium described herein may further include operations, features, means, code, or instructions for receiving, from the second network node, a signal that configures the duration of the operational state for the first network node.

In some aspects of the method, first network node, apparatus, and non-transitory computer-readable medium described herein, the signal configures a periodicity for a set of multiple durations of the operational state for the first network node.

Some aspects of the method, first network node, apparatus, and non-transitory computer-readable medium described herein may further include operations, features, means, code, or instructions for transmitting, to the second network node, a request for a modification to the timing information and receiving, from the second network node and based on the request, an indication of the modification to the timing information, where modifying the timing information may include modifying the timing information based on the indication of the modification to the timing information.

In some aspects of the method, first network node, apparatus, and non-transitory computer-readable medium described herein, the indication of the modification to the timing information includes a lookup table, a lookup table index, a codepoint, a value, or any combination thereof.

Some aspects of the method, first network node, apparatus, and non-transitory computer-readable medium described herein may further include operations, features, means, code, or instructions for transmitting, to the second network node, a signal that includes a first indication of the duration of the operational state for the first network node, a second indication of the modified duration of the operational state, or both, where the communication with the second network node may be based on the first indication of the duration of the operational state, the second indication of the modified duration of the operational state, or both.

In some aspects of the method, first network node, apparatus, and non-transitory computer-readable medium described herein, the signal includes an energy report, a scheduling request (SR), a hybrid automatic repeat request (HARQ) signal, a buffer status report (BSR), a random access channel (RACH) signal, an uplink control information (UCI) signal, or any combination thereof.

In some aspects of the method, first network node, apparatus, and non-transitory computer-readable medium described herein, transmitting the signal may include operations, features, means, code, or instructions for backscattering the signal based on a power availability of the first network node.

In some aspects of the method, first network node, apparatus, and non-transitory computer-readable medium described herein, the first network node may be unavailable to communicate information with the second network node during the modified duration of the operational state.

A method of wireless communications performed by a first network node is described. The method may include transmitting, for a second network node, timing information corresponding to a timer, modifying, based on an overlap in time of a duration of the timer and a duration of an operational state for the second network node, at least one of the timing information or the duration of the operational state, and communicating with the second network node in accordance with the modified timing information or the modified duration of the operational state.

A first network node for wireless communication is described. The first network node may include a memory and at least one processor coupled to the memory. The at least one processor may be configured to transmit, for a second network node, timing information corresponding to a timer, modify, based on an overlap in time of a duration of the timer and a duration of an operational state for the second network node, at least one of the timing information or the duration of the operational state, and communicate with the second network node in accordance with the modified timing information or the modified duration of the operational state.

An apparatus for wireless communications at a first network node is described. The apparatus may include means for transmitting, for a second network node, timing information corresponding to a timer, means for modifying, based on an overlap in time of a duration of the timer and a duration of an operational state for the second network node, at least one of the timing information or the duration of the operational state, and means for communicating with the second network node in accordance with the modified timing information or the modified duration of the operational state.

A non-transitory computer-readable medium having code for wireless communication stored thereon is described. The code, when executed by a first network node, may cause the first network node to transmit, for a second network node, timing information corresponding to a timer, modify, based on an overlap in time of a duration of the timer and a duration of an operational state for the second network node, at least one of the timing information or the duration of the operational state, and communicate with the second network node in accordance with the modified timing information or the modified duration of the operational state.

Some aspects of the method, first network node, apparatus, and non-transitory computer-readable medium described herein may further include operations, features, means, code, or instructions for transmitting, for the second network node, a signal that configures a first delta value for the second network node, where modifying at least one of the timing information or the duration of the operational state may include modifying the duration of the timer or the duration of the operational state based on the first delta value.

Some aspects of the method, first network node, apparatus, and non-transitory computer-readable medium described herein may further include operations, features, means, code, or instructions for receiving, for the second network node, a wake-up signal response that includes a request for a second delta value for the second network node and determining the first delta value based on the request.

In some aspects of the method, first network node, apparatus, and non-transitory computer-readable medium described herein, the timer includes a BWP inactivity timer, a BWP switching delay timer, an SSSG switching timer, an SCell deactivation timer, a DRX inactivity timer, a short DRX timer, or a long DRX timer.

Some aspects of the method, first network node, apparatus, and non-transitory computer-readable medium described herein may further include operations, features, means, code, or instructions for transmitting, for the second network node, a signal that configures the duration of the operational state for the second network node.

Some aspects of the method, first network node, apparatus, and non-transitory computer-readable medium described herein may further include operations, features, means, code, or instructions for receiving, for the second network node, a signal that includes a first indication of the duration of the operational state for the second network node, a second indication of the modified duration of the operational state, or both, where the communication with the second network node may be based on the first indication of the duration of the operational state, the second indication of the modified duration of the operational state, or both.

### BRIEF DESCRIPTION OF THE DRAWINGS

FIG. 1 shows an example of a wireless communications system that supports timing modifications for devices based on operational states in accordance with one or more aspects of the present disclosure.

FIG. 2 shows an example of a network architecture that supports timing modifications for devices based on operational states in accordance with one or more aspects of the present disclosure.

FIG. 3 shows an example of a wireless communications system that supports timing modifications for devices based on operational states in accordance with one or more aspects of the present disclosure.

FIGS. 4A and 4B show examples of timelines that support timing modifications for devices based on operational states in accordance with one or more aspects of the present disclosure.

FIG. 5 shows an example of a downlink control information (DCI) event that supports timing modifications for devices based on operational states in accordance with one or more aspects of the present disclosure.

FIG. 6 shows an example of a process flow that supports timing modifications for devices based on operational states in accordance with one or more aspects of the present disclosure.

FIGS. 7 and 8 show block diagrams of devices that support timing modifications for devices based on operational states in accordance with one or more aspects of the present disclosure.

FIG. 9 shows a block diagram of a communications manager that supports timing modifications for devices based on operational states in accordance with one or more aspects of the present disclosure.

FIG. 10 shows a diagram of a system including a device that supports timing modifications for devices based on operational states in accordance with one or more aspects of the present disclosure.

FIGS. 11 and 12 show block diagrams of devices that support timing modifications for devices based on operational states in accordance with one or more aspects of the present disclosure.

FIG. 13 shows a block diagram of a communications manager that supports timing modifications for devices based on operational states in accordance with one or more aspects of the present disclosure.

FIG. 14 shows a diagram of a system including a device that supports timing modifications for devices based on operational states in accordance with one or more aspects of the present disclosure.

FIGS. 15 through 19 show flowcharts illustrating methods that support timing modifications for devices based on operational states in accordance with one or more aspects of the present disclosure.

### DETAILED DESCRIPTION

In some wireless communications systems, a network node (e.g., a user equipment (UE)) may operate according to an operational state during which the network node is unavailable for communicating information. In some cases, the network node may be an example of an energy harvesting device. The network node may operate according to an energy harvesting operational state during which the network node harvests energy (e.g., radio frequency (RF) energy, solar energy, thermal energy, laser energy) to improve the available power at the network node. Some energy harvesting architectures (e.g., a time-switching architecture) may fail to support concurrent energy harvesting and information communication. Additionally, or alternatively, a network node may operate according to a relatively low power operational state during which the network node refrains from performing one or more operations (e.g., communications, RF tuning) to support power savings.

If such an operational state overlaps (e.g., fully or partially) with an active duration of a timer for a network node (e.g., a UE), one or more network nodes (e.g., the UE, a network entity) may modify timing information to account for the operational state during which the network node is unavailable for communicating information, RF tuning, or both. For example, a first network node (e.g., a UE) may receive, from a second network node (e.g., a network entity or base station), timing information corresponding to a timer. The timer may be an example of a bandwidth part (BWP) inactivity timer, a BWP switch timer, a search space set group (SSSG) switch timer, a secondary cell (SCell) inactivity timer, or any other timer configured for the first network node. If an active duration of the timer at least partially overlaps in time with an active duration of the operational state for the first network node, the first network node may modify at least one of the timing information corresponding to the timer or the duration of the operational state. In some cases, the first network node may modify a duration of the timer, cancel the timer, or pause the timer based on the overlap. Additionally, or alternatively, the first network node may modify the duration of the operational state or cancel the operational state (e.g., cancel an energy harvesting opportunity) based on the overlap. The first network node may communicate with the second network node in accordance with the modified timing information or the modified duration of the operational state. The first network node and the second network node may perform similar timing modifications to support coordination and timing alignment between the first network node (e.g., the UE) and the second network node (e.g., the network entity).

Aspects of the disclosure are initially described in the context of wireless communications systems. Additional aspects of the disclosure are described with reference to timelines, a downlink control information (DCI) event, and a process flow. Aspects of the disclosure are further illustrated by and described with reference to apparatus diagrams, system diagrams, and flowcharts that relate to timing modifications for devices based on operational states.

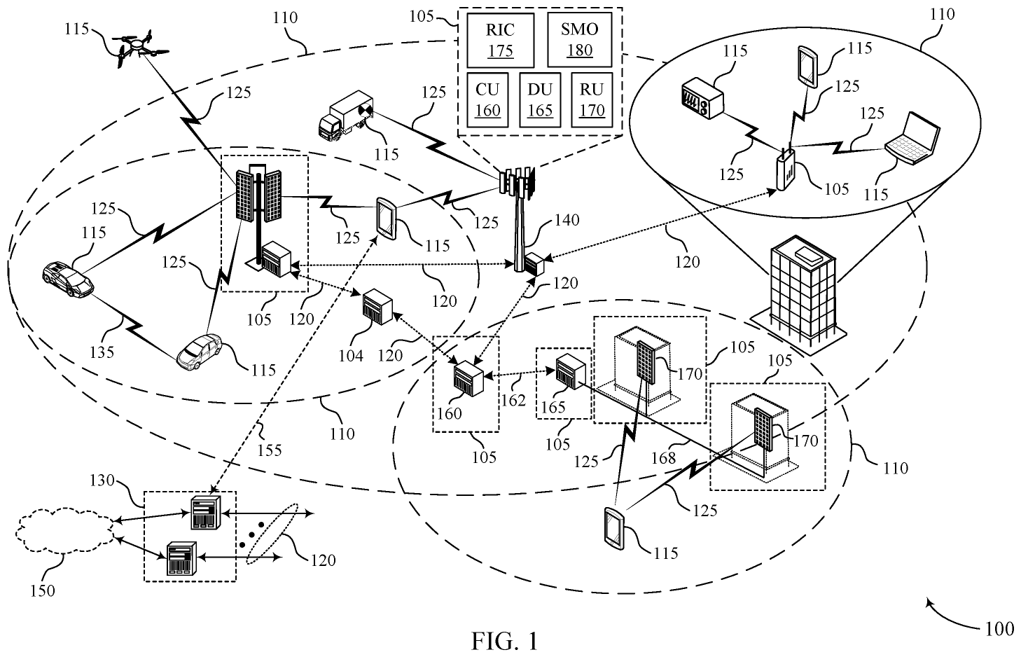

FIG. 1 shows an example of a wireless communications system 100 that supports timing modifications for devices based on operational states in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE 115. As another example, a network node may be a base station or network entity 105. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. The example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another via a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support timing modifications for devices based on operational states as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other aspects, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some aspects, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs 115 via a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other aspects, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some aspects, a device may support same-slot HARQ feedback, in which case the device may provide HARQ feedback in a specific slot for data received via a previous symbol in the slot. In some other aspects, the device may provide HARQ feedback in a subsequent slot, or according to some other time interval.

In some systems, a UE 115 (e.g., a first network node) or another network node may be an example of an energy harvesting device. An energy harvesting device may support one or more techniques for harvesting energy (e.g., charging a battery, otherwise improving a level of available power at the device) during an energy harvesting duration. For example, the energy harvesting device may harvest RF energy, solar energy, thermal energy, laser energy, or any combination of these or other energy sources.

The energy harvesting device may implement a specific scheme for harvesting energy, for example, based on an architecture of the device. For example, an energy harvesting device that uses RF energy may implement a separated receiver architecture, a power-splitting architecture, a time-switching architecture, or some combination thereof to receive RF energy for energy harvesting. In a separated receiver architecture, the network node may include separate receivers for receiving RF energy for harvesting and for receiving information. In a power-splitting architecture, the network node may receive an RF signal and may split the power of the RF signal to be used for both energy harvesting and information reception. For both the separated receiver architecture and the power-splitting architecture, the network node may perform RF energy harvesting and information communication (e.g., information reception) concurrently. For example, a radio frequency identification (RFID) device may perform concurrent energy harvesting and data communication. Additionally, or alternatively, the energy harvesting device using the separated receiver or power-splitting architecture may perform energy harvesting without a time offset or gap between data communications and the energy harvesting.

In contrast, in a time-switching architecture, the network node may receive an RF signal and may use the RF signal for energy harvesting or for information communication (e.g., information reception) at different times. For example, the network node may dedicate a first portion of time for energy harvesting and a second, different portion of time for data reception. Accordingly, for the time-switching architecture, the network node may be unavailable for information reception (e.g., unable to receive a signal for information processing) when the network node is performing RF energy harvesting. For example, even if the network node performs the RF energy harvesting in-band, from a current serving cell, or both, the network node may be unavailable for concurrent data communications with the serving cell based on the network node's RF energy harvesting architecture. The energy harvesting device using the time-switching architecture may include a time offset or gap between data communications and the energy harvesting to support switching between data communications and energy harvesting (e.g., switching hardware modes of operation). The energy harvesting device may add a time offset or gap before entering an energy harvesting duration and after ending the energy harvesting duration. Alternatively, the energy harvesting duration may include the time offsets or gaps before and after performing energy harvesting. The energy harvesting device may be unavailable for data communications during the time offsets or gaps. The energy harvesting device may determine a length of a time offset or gap based on a capability of the device, a configuration from the network, coordination with the network, or any combination thereof.

Additionally, or alternatively, the network node (e.g., a UE 115) may perform RF energy harvesting using a different RAT (e.g., LTE, WiFi, Bluetooth, sidelink) or a different frequency band (e.g., a specific band, such as an ISM band, or a band dedicated by a serving cell) than a RAT or frequency band used for data communications. In such cases, the network node may perform RF tuning (e.g., during a measurement gap between data communications and energy harvesting, or without a gap). For example, the network node may tune a radio (e.g., a receiver) from a first RAT, a first frequency band, or both corresponding to data communications to a second RAT, a second frequency band, or both corresponding to energy harvesting to support performing RF energy harvesting. Similarly, the network node may tune the radio from the second RAT, the second frequency band, or both back to the first RAT, the first frequency band, or both to support performing data communications (e.g., following RF energy harvesting). In a time-switching architecture, the network node may be unavailable for data communications during the tuning, for example, in addition to during the RF energy harvesting operations.

In some cases, the network node may be unavailable for information communication during other types of energy harvesting. For example, based on the hardware of the network node, the network node may fail to support concurrent energy harvesting and information communication (e.g., reference signal (RS) processing, data processing). Additionally, or alternatively, an energy harvesting operation at the network node may involve a significant processing overhead (e.g., above a threshold), and the network node may refrain from performing information communication based on the processing overhead of the energy harvesting.

For non-RF energy harvesting (e.g., solar energy harvesting, thermal energy harvesting, laser energy harvesting, vibrational energy harvesting), an energy harvesting device may support an RF tuning capability. The RF tuning capability may support the device tuning to a new BWP per band, band combination, component carrier (CC), CC combination, BWP, BWP combination, or any combination thereof. For RF energy harvesting, the energy harvesting device may support a different RF tuning capability (e.g., including a time gap between data and energy harvesting). If the energy harvesting device communicates data via first cell, network, RF technology, band, or combination thereof, and performs energy harvesting via a second cell, network, RF technology (e.g., RAT, such as WiFi, Bluetooth, LTE, sidelink non-overlapping with an access link BWP), band, or combination thereof, the energy harvesting device may perform RF tuning between the configuration for data communications (e.g., via the first cell, which may be a serving cell) and the configuration for energy harvesting. If the energy harvesting device communicates data and performs RF energy harvesting via the same cell (e.g., the serving cell), the RF tuning may be based on the architecture of the energy harvesting device, the band or BWP used by the energy harvesting device, or both. If the device communicates data and performs energy harvesting via a same band or BWP, the device may have a gap during which the device is unavailable for communications if the device uses a time-switching architecture. If the device communicates data and performs energy harvesting via different bands, BWPs, or resources with a band, CC, or BWP, the device may perform RF tuning regardless of the energy harvesting architecture of the device.

Energy harvesting cycles may be periodic. In some cases, the network (e.g., a network entity 105) may configure the energy harvesting cycle for a UE 115. Additionally, or alternatively, the UE 115 and the network entity 105 may negotiate the energy harvesting cycle (e.g., if the UE 115 uses a different RAT, network, band, or technology for the energy harvesting). The UE 115 may suggest an energy harvesting cycle, and the network entity 105 may confirm or otherwise configure the energy harvesting cycle based on the suggestion. In some aspects, the network entity 105 may dynamically indicate the energy harvesting cycle, an energy harvesting duration, or both to the UE 115. Alternatively, the UE 115 may dynamically indicate the energy harvesting cycle, an energy harvesting duration, or both to the network entity 105. For example, the UE 115 may indicate the energy harvesting duration or another unavailable duration (e.g., a duration of a low-power mode during which the UE 115 may be unavailable for communications) via L1, L2, or L3 signaling. Additionally, or alternatively, the network entity 105 may receive an energy report (e.g., from the UE 115) indicating an energy charging profile for the UE 115, a discharging profile for the UE 115, an energy state profile for the UE 115, or any combination thereof. The network entity 105 may determine the energy harvesting duration based on the energy report.

Additionally, or alternatively, a network node (e.g., a UE 115) may be unavailable for information communication for other reasons. For example, if the network node is operating with a low power (e.g., below a power threshold), the network node may refrain from performing some operations (e.g., RS processing, data processing) to conserve power at the network node. The network node may enter a low energy or low power state (e.g., a low power operating state) in which the network node may fail to support monitoring a channel, measuring an RS, receiving a signal, processing a signal, transmitting a signal, or any combination thereof, effectively causing the network node to be unavailable for communications. In some cases, a network node may be “busy” (e.g., performing one or more other operations) and may be unavailable for information communication based on being busy.

Some wireless communications systems 100 may support different operational states for network nodes (e.g., UEs 115). An operational state at the network node may correspond to a specific behavior for one or more network nodes (e.g., a UE 115, a network entity 105). In some cases, the specific behavior may be associated with performing a BWP switch (e.g., from a first BWP to a second BWP, such as a new BWP for data communications). For example, if the network node starts an energy harvesting active duration within a discontinuous reception (DRX) ON duration, the network node may determine whether to adjust (e.g., stop, modify) one or more MAC timers based on the operational state of the network node.

A first operational state may involve a network node (e.g., a UE 115) performing energy harvesting (e.g., operating within an active energy harvesting duration) and the network node failing to satisfy an energy threshold (e.g., an energy threshold associated with having enough energy to perform RF tuning to a new data BWP). A second operational state may involve the network node performing energy harvesting (e.g., operating within an active energy harvesting duration) and the network node satisfying the energy threshold (e.g., the network node having enough energy for RF tuning to the new data BWP). A third operational state may involve the network node not performing energy harvesting (e.g., performing information communications or otherwise being outside an energy harvesting duration) and the network node satisfying the energy threshold (e.g., the network node having enough energy for RF tuning to the new data BWP). A fourth operational state may involve the network node not performing energy harvesting (e.g., performing information communications or otherwise being outside an energy harvesting duration) and the network node failing to satisfy the energy threshold (e.g., an energy threshold associated with having enough energy to perform RF tuning to a new data BWP). In some cases, the network node may support additional, or alternative, operational states. An operational state may correspond to a respective timer change, behavior, or both for the network node. For example, the network node may use a BWP inactivity timer, a BWP switching delay timer, or both for performing the BWP switch. The network node may apply a delta timer extension, a different timer duration, or both for the BWP inactivity timer, the BWP switching delay timer, or both based on the operational state of the network node. In some cases, a UE 115 and a network entity 105 serving the UE 115 may use the same timer change, behavior, or both based on the operational state of the UE 115 to coordinate timing between the UE 115 and the network entity 105 (e.g., between network nodes).

For example, a first network node (e.g., a UE 115) may operate according to an operational state during which the network node is unavailable for communicating information (e.g., based on energy harvesting using a time-switching architecture, a configured time offset or gap, an RF tuning procedure, a low power mode, or any combination thereof). The network node may modify timing to account for the operational state. The UE 115 may receive, from a second network node (e.g., a network entity 105 or base station), timing information corresponding to a timer. If an active duration of the timer at least partially overlaps in time with an active duration of the operational state for the UE 115, the UE 115 may modify at least one of the timing information or the duration of the operational state. In some cases, the UE 115 may modify a duration of the timer, cancel the timer, pause the timer, modify the duration of the operational state, cancel the operational state, or any combination thereof based on the overlap. Similarly, the network entity 105 may modify at least one of the timing information or the duration of the operational state based on the overlap. The UE 115 and the network entity 105 may communicate based on the modified timing information or the modified duration of the operational state.

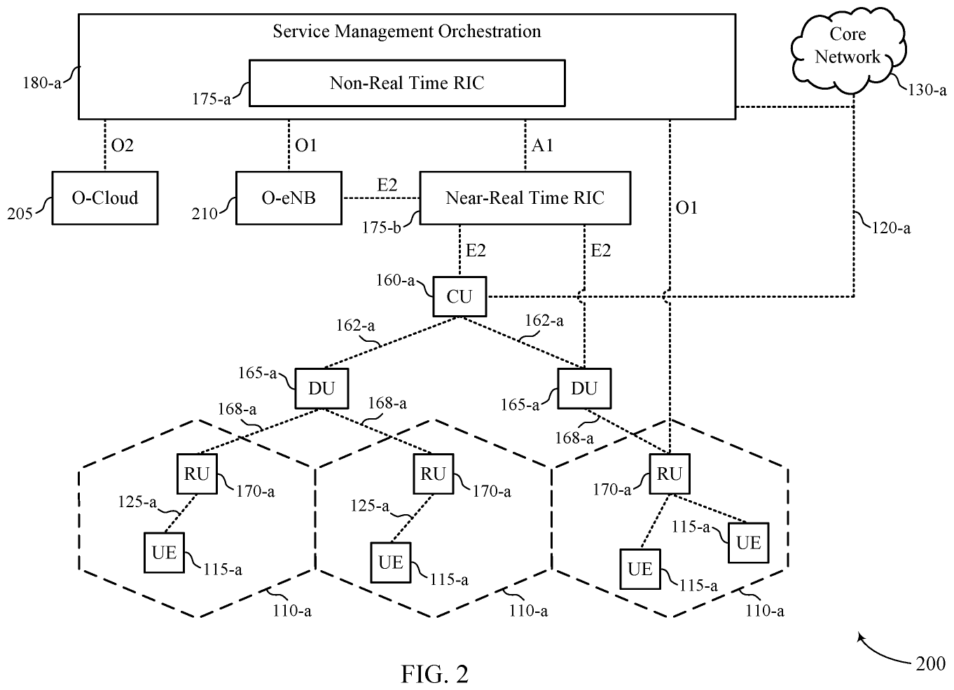

FIG. 2 shows an example of a network architecture 200 that supports timing modifications for devices based on operational states in accordance with one or more aspects of the present disclosure. The network architecture 200 may be an example of a disaggregated base station architecture, a disaggregated RAN architecture, or both. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some aspects, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some aspects, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some aspects, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) based on a functional split, such as those defined by the 3rd Generation Partnership Project (3GPP). In some aspects, a DU 165-a may further host one or more low PHY layers. Each layer may be implemented with an interface configured to communicate signals with other layers hosted by the DU 165-a, or with control functions hosted by a CU 160-a.

In some aspects, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some aspects, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some aspects, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some aspects, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

In some systems, a network entity 105 (e.g., a CU 160-a, a DU 165-a, an RU 170-a) may communicate with a UE 115-a based on one or more timing modifications in accordance with an operational state of the UE 115-a. For example, a first network node (e.g., a CU 160-a, a DU 165-a, an RU 170-a, or a combination thereof) may send, for a second network node (e.g., a UE 115-a) timing information corresponding to a timer. The first network node (e.g., the CU 160-a, the DU 165-a, the RU 170-a, or the combination thereof) may modify, based on an overlap in time of a duration of the timer and a duration of an operational state for the second network node (e.g., the UE 115-a), at least one of the timing information or the duration of the operational state. The first network node (e.g., the CU 160-a, the DU 165-a, the RU 170-a, or the combination thereof) may communicate (e.g., directly or via one or more other network nodes) with the second network node (e.g., the UE 115-a) in accordance with the modified timing information or the modified duration of the operational state.

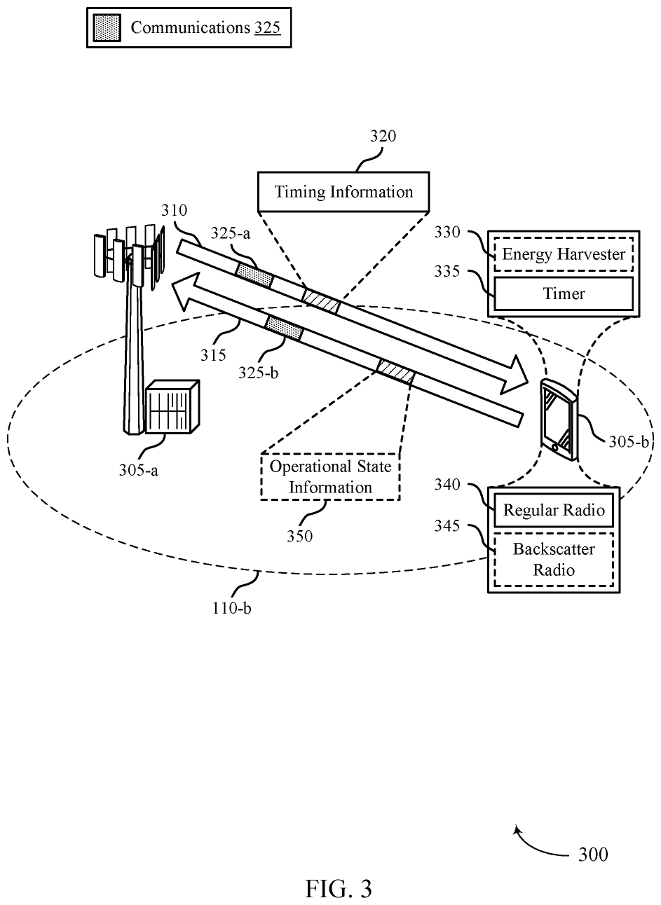

FIG. 3 shows an example of a wireless communications system 300 that supports timing modifications for devices based on operational states in accordance with one or more aspects of the present disclosure. The wireless communications system 300 may be an example of a wireless communication system 100 or a network architecture 200 as described herein with reference to FIGS. 1 and 2. The wireless communications system 300 may include a first network node 305-a and a second network node 305-b. In some cases, the first network node 305-a may be an example of a network entity 105, such as a CU, a DU, an RU, a base station, or some other network entity serving a coverage area 110-b. The second network node 305-b may be an example of a UE 115. In some systems, a network node (e.g., the second network node 305-b) may operate according to an operational state during which the network node is unavailable for communications 325. For example, the second network node 305-b may perform energy harvesting, enter a relatively low power state (e.g., a battery-saving state), or otherwise operate according to an operational state that fails to support communications 325 (e.g., downlink data reception, uplink data transmission, or both). The first network node 305-a, the second network node 305-b, or both may modify timing information 320, a duration of the operational state, or both to account for the second network node 305-b being unavailable for communications 325 during the duration of the operational state.

The second network node 305-b (e.g., a UE 115) may store timing information 320 corresponding to one or more timers 335. In some aspects, the first network node 305-a may configure the timing information 320 for the second network node 305-b. The timing information 320 may configure a duration for a timer 335, a trigger event for starting a timer 335, a pause event for pausing a timer 335, a cancel event for stopping a timer 335, or any combination of these or other information relating to a timer 335. While a timer 335 is active (e.g., running prior to expiration of the timer 335) at the second network node 305-b, the second network node 305-b may perform one or more operations (e.g., channel monitoring, BWP switching, SSSG switching) associated with the timer 335. For example, if the timer 335 is an example of an inactivity timer (e.g., a BWP inactivity timer), the second network node 305-b may (periodically or aperiodically) monitor a BWP for downlink control information (DCI) from a network entity 105 (e.g., the first network node 305-a). If the second network node 305-b fails to receive DCI prior to expiration of the BWP inactivity timer, the second network node 305-b may switch to operate via a different BWP (e.g., a fallback BWP to save energy).

However, if the second network node 305-b enters an operational state that fails to support the operations for an active timer 335 (e.g., fails to support channel monitoring, BWP switching, SSSG switching), the second network node 305-b may modify timing information 320, a duration of the operational state, or both. For example, if the second network node 305-b enters an operational state in which the second network node 305-b is unavailable for communications 325 (e.g., based on a power state of the second network node 305-b, based on other operations performed by the second network node 305-b) while the BWP inactivity timer is active, the second network node 305-b may fail to support monitoring for DCI during the duration of the operational state.

In some aspects, to account for the duration of the operational state during which the second network node 305-b is unavailable for communications 325, the second network node 305-b may modify the timer 335. For example, the second network node 305-b may extend a duration of the timer 335, pause the timer 335 (e.g., temporarily stop running the timer 335), stop the timer 335 (e.g., stop running the timer 335, resetting the timer 335 to a configured timer duration), change the timer 335 (e.g., adjust a count for the timer 335, activate a different timer 335), or any combination thereof. Accordingly, the second network node 305-b may modify the timing information 320 configured for the timer 335. For example, the second network node 305-b may modify the BWP inactivity timer based on the second network node 305-b being unavailable (e.g., unavailable for DCI monitoring while performing energy harvesting) during an active duration of the BWP inactivity timer.

In some cases, the second network node 305-b may adjust a duration of the timer 335 (e.g., the BWP inactivity timer) by a delta value. For example, the second network node 305-b may add the delta value (e.g., “deltaTimer”) to the duration of the timer 335 to increase the duration of the timer 335 to account for the duration of the operational state (e.g., the duration during which the second network node 305-b may be unavailable for communications 325). In some aspects, the first network node 305-a may configure the delta value for the timer 335. The first network node 305-a may configure a single delta value or may configure multiple delta values, where the second network node 305-b may select a delta value to use from the multiple delta values. Additionally, or alternatively, the delta value for the timer 335 may change dynamically, for example, as a function of the duration of the operational state. If the operational state is for energy harvesting, the delta value for the timer 335 may be based on (e.g., equal to) an energy harvesting duration for the second network node 305-b. In some aspects, the energy harvesting duration may include the time used for the second network node 305-b to switch from communicating data to energy harvesting and to switch back from energy harvesting to communicating data. In some other aspects, the energy harvesting duration may not include the time for these switches. In some such other examples, the delta value may account for the time to switch from communicating data to energy harvesting, the time to switch back from energy harvesting to communicating data, or both. Accordingly, the second network node 305-b may extend the BWP inactivity timer duration by the energy harvesting duration such that the second network node 305-b monitors the BWP for DCI for the BWP inactivity timer duration, regardless of the energy harvesting duration during which the second network node 305-b refrains from monitoring the BWP for the DCI.

In some aspects, the first network node 305-a may configure a timer adjustment (e.g., one or more delta values) for the second network node 305-b via a wake-up signal (e.g., a wake-up signal indication). Additionally, or alternatively, the second network node 305-b may request a timer adjustment via a wake-up signal response. The first network node 305-a and the second network node 305-b may negotiate the timer adjustment (e.g., where the first network node 305-a may select a timer adjustment based on a request from the second network node 305-b) via L1 signaling, L2 signaling, L3 signaling, or a combination thereof. In some cases, the first network node 305-a may adjust the timer adjustment over time.

In some cases, the timer 335 may be an example of an SSSG switching timer. For example, the second network node 305-b may switch from operating according to a first SSSG to operating according to a second SSSG (e.g., SSSG #1 or SSSG #2). A first slot after the switch, the second network node 305-b may activate the SSSG switching timer. The second network node 305-b may monitor for a DCI signal (e.g., periodically or aperiodically) according to the second SSSG while the SSSG switching timer is active (e.g., running for an SSSG switching timer duration). The second network node 305-b may reset the SSSG switching timer if the second network node 305-b detects a DCI signal with a CRC scrambled by a cell radio network temporary identifier (C-RNTI), a configured scheduling radio network temporary identifier (CS-RNTI), a modulation and coding scheme cell radio network temporary identifier (MCS-C-RNTI) (e.g., for unicast physical downlink control channel (PDCCH) signaling), or any combination thereof. If the SSSG switching timer expires (e.g., a timer value reaches zero corresponding to the configured SSSG switching timer duration) before the second network node 305-b detects the DCI signal for the second SSSG, the second network node 305-b may fallback to monitoring for PDCCH signaling according to a default SSSG (e.g., SSSG #0), for example, after an application delay. The first network node 305-a may configure the SSSG switching timer duration per BWP (e.g., via timing information 320 corresponding to the timer 335). In some cases, the SSSG switching timer duration may be common for falling back from SSSG #1 to SSSG #0 and for falling back from SSSG #2 to SSSG #0.

In some cases, an operational state during which the second network node 305-b is unavailable for communications (e.g., an energy harvesting duration using an energy harvester 330) may overlap with the active duration of the SSSG switching timer. The second network node 305-b may modify the duration of the SSSG switching timer to account for the second network node 305-b failing to support monitoring for DCI during the duration of the operational state. For example, the second network node 305-b may dynamically extend the duration of the SSSG switching timer. If the first network node 305-a identifies the operational state of the second network node 305-b (e.g., identifies an energy harvesting cycle, energy harvesting duration, or both of the second network node 305-b), the first network node 305-a may indicate a timer adjustment for the SSSG switching timer via L1 signaling, L2 signaling, L3 signaling, or any combination thereof. In some aspects, the first network node 305-a may identify the operational state for the second network node 305-b based on the first network node 305-a configuring the operational state for the second network node 305-b. In some other aspects, the first network node 305-a may identify the operational state for the second network node 305-b based on receiving operational state information 350 (e.g., indicating an energy harvesting cycle, energy harvesting duration, or both for the second network node 305-b) from the second network node 305-b.

In some cases, the first network node 305-a and the second network node 305-b may negotiate values, tables (e.g., look-up tables), or both for configuring timing adjustments based on an operational state (e.g., an energy harvesting cycle). In some aspects, the second network node 305-b may select a timing adjustment (e.g., a delta value for a timer 335) and may transmit an indication of the selected timing adjustment to the first network node 305-a for a dynamic delta change. The second network node 305-b may transmit the selected timing adjustment as a timing modification suggestion, for example, via dedicated physical uplink control channel (PUCCH) resources, via configured PUCCH resources (e.g., associated with an energy harvesting cycle), multiplexed with L1, L2, or L3 signaling (e.g., HARQ-ACK information, a scheduling request (SR), a buffer status report (BSR), a RACH message, a power headroom (PHR) signal), included with L1, L2, or L3 signaling, or any combination thereof. The first network node 305-a may respond by confirming the selected timing adjustment (e.g., delta value) or may select a different timing adjustment, for example, based on the timing adjustment selected by the second network node 305-b. The second network node 305-b, the first network node 305-a, or both may use the timing adjustment to modify the duration of the SSSG switching timer based on the overlap with the operational state (e.g., an energy harvesting duration).

In some cases, the timer 335 may be an example of an SCell inactivity timer. The second network node 305-b may track one or more secondary cells (e.g., corresponding to one or more other network nodes). The second network node 305-b may modify timing information for one or more timers 335 associated with a secondary cell based on an operational state at the second network node 305-b. For example, the second network node 305-b may extend or otherwise modify (e.g., pause, cancel) an SCell inactivity timer based on an overlap of the SCell inactivity timer active duration with an operational state of the second network node 305-b during which the second network node 305-b is unavailable for communications (e.g., fails to monitor for signaling from the secondary cell).

In some cases, the first network node 305-a may fail to identify the operational state for the second network node 305-b. For example, the second network node 305-b may perform energy harvesting independent of the first network node 305-a, such that the first network node 305-a may fail to determine an energy harvesting cycle, an energy harvesting duration, or both for the second network node 305-b. Accordingly, the first network node 305-a may fail to identify the specific times at which the second network node 305-b may be unavailable for communications 325.

In some aspects, the second network node 305-b may indicate, to the first network node 305-a, a start of an operational state during which the second network node 305-b may be unavailable for communications 325, a duration of the operational state, or both. For example, the second network node 305-b may transmit the indication prior to the second network node 305-b entering the operational state. The indication may be transmitted via L1 signaling, L2 signaling, L3 signaling, or some combination thereof. For example, the second network node 305-b may transmit the indication piggybacked, multiplexed, or otherwise included with an SR, HARQ-ACK information, a BSR, a RACH message, UCI, or any other uplink signaling. In some cases, the second network node 305-b may transmit a dedicated L1, L2, or L3 indication (e.g., via dynamic or configured uplink resources). For example, the second network node 305-b may transmit the indication via configured resources associated with a potential energy harvesting cycle (e.g., where the energy for harvesting may or may not come from the network). Such resources may be configured by the first network node 305-a, the second network node 305-b, or a combination thereof.

The first network node 305-a and the second network node 305-b may communicate in accordance with the modified timing. For example, the first network node 305-a may transmit communications 325-a via a downlink channel 310 to the second network node 305-b based on one or more modified timers 335, modified operational state durations, or both. Similarly, the second network node 305-b may transmit communications 325-b via an uplink channel 315 to the first network node 305-a based on the one or more modified timers 335, the modified operational state durations, or both.

In some cases, the second network node 305-b may include multiple radios for different types of communications. For example, the second network node 305-b may include a “regular” radio 340 for information communications and a backscatter radio 345 (or “Tag” radio) for backscattering signals. The second network node 305-b may use one or more backscattering techniques via the backscatter radio 345 to save power (e.g., when operating at a relatively low power state, when the regular radio 340 is unavailable for communications). For example, the second network node 305-b may multiplex signaling via backscattering techniques to support backscattering communications (e.g., even if the second network node 305-b may be otherwise unavailable for communications 325).

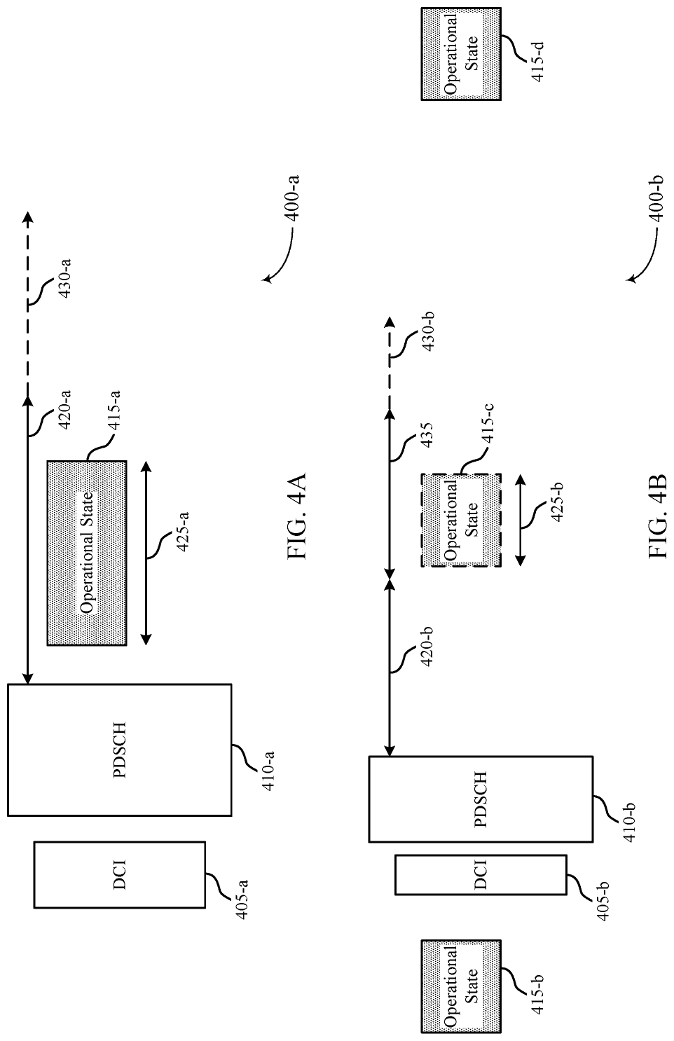

FIGS. 4A and 4B show examples of timelines that support timing modifications for devices based on operational states in accordance with one or more aspects of the present disclosure. FIG. 4A shows an example of a timeline 400-a that supports timing modifications for devices based on operational states in accordance with one or more aspects of the present disclosure. A network node (e.g., a UE 115, a network entity 105) may modify timing information in accordance with the timeline 400-a to account for an operational state 415-a during which a network node (e.g., a UE 115) may be unavailable for communications.

A first network node (e.g., a UE 115) may monitor for and receive DCI 405-a during a first set of resources. The first network node may receive physical downlink shared channel (PDSCH) signaling 410-a during a second set of resources. For example, the DCI 405-a may schedule the PDSCH signaling 410-a. Following the PDSCH reception, the first network node may activate an inactivity timer (e.g., a BWP inactivity timer based on the first network node operating in a DRX mode). The activated inactivity timer may run for a duration 420-a before expiration of the inactivity timer. For example, the first network node may be configured with timing information indicating the duration 420-a for the inactivity timer. While the inactivity timer is running (e.g., the inactivity timer is active), the first network node may monitor (e.g., periodically) for additional DCI from the network. If the first network node receives DCI while the inactivity timer is running, the first network node may stop the inactivity timer and reset the inactivity timer. The first network node may perform communications (e.g., uplink transmission, downlink reception) scheduled by the received DCI. If the first network node fails to receive DCI while the inactivity timer is running, upon expiration of the inactivity timer (e.g., following the duration 420-a), the first network node may switch to a different BWP (e.g., fall back to a default or power saving BWP).

However, in some cases, the duration 420-a of the inactivity timer may overlap (e.g., partially or fully) with a duration 425-a of an operational state 415-a. For example, the first network node may enter an operational state 415-a (e.g., an energy harvesting mode, a power saving mode). During the operational state 415-a, the first network node may refrain from (e.g., fail to support) communicating information. For example, the first network node may be unavailable for receiving control information, receiving data, transmitting control information, transmitting data, or any combination thereof while the first network node operates according to the operational state 415-a. As such, during the duration 425-a, the first network node may refrain monitoring for DCI while the inactivity timer is running. The first network node may extend the duration 420-a of the inactivity timer based on the duration 425-a of the operational state 415-a. For example, the first network node may add a delta value 430-a to the duration 420-a of the inactivity timer based on the duration 425-a of the operational state 415-a. In some cases, the delta value 430-a may be equal to the duration 425-a of the operational state 415-a. Based on the delta value 430-a, the first network node may monitor for DCI for the duration 420-a despite a gap of duration 425-a during which the first network node fails to support monitoring the DCI.

FIG. 4B shows an example of a timeline 400-b that supports timing modifications for devices based on operational states in accordance with one or more aspects of the present disclosure. A network node (e.g., a UE 115, a network entity 105) may modify timing information in accordance with the timeline 400-b to account for an operational state 415-b during which a network node (e.g., a UE 115) may be unavailable for communications, RF tuning, or both.

A first network node (e.g., a UE 115) may monitor for and receive DCI 405-b during a first set of resources. The first network node may receive PDSCH signaling 410-b during a second set of resources. For example, the DCI 405-b may schedule the PDSCH signaling 410-b. Following the PDSCH reception, the first network node may activate an inactivity timer (e.g., a BWP inactivity timer for a first BWP) for a duration 420-b. If the first network node fails to receive DCI during the duration 420-b of the inactivity timer, the first network node may trigger a BWP switch from the first BWP to a second BWP. The first network node may activate a BWP switching delay timer to support the BWP switch. The first network node may be configured with timing information indicating the duration 435 for the BWP switching delay timer. While the BWP switching delay timer is active (e.g., running), the first network node may switch from the first BWP to a second BWP. The BWP switch may involve the first network node tuning a radio (e.g., a receiver) to the second BWP. During the BWP switch, the first network node may be unavailable for communications.

However, in some cases, the duration 435 of the BWP switching delay timer may overlap (e.g., partially or fully) with a duration 425-b of an operational state 415-c. For example, the first network node may be configured to periodically enter an operational state. Based on the periodicity, the first network node may operate according to an operational state 415-b, an operational state 415-c, and an operational state 415-d. For example, the first network node may perform energy harvesting during periodic occasions. During the periodic operational states, the first network node may refrain from (e.g., fail to support) communicating information. Additionally, or alternatively, the first network node may fail to support RF tuning (e.g., supporting a BWP switch) during the duration 425-b of the operational state 415-c. In some cases, the first network node may fail to support the RF tuning based on a power level of the first network node. In some other cases, the first network node may fail to support RF tuning to the second BWP during the duration 425-b of the operational state 415-c based on the first network node instead performing RF tuning to a BWP for energy harvesting during the duration 425-b of the operational state 415-c.

In some cases, if the duration 425-b of the operational state 415-c overlaps with the duration 435 of the BWP switching delay timer, the first network node may cancel the duration 425-b of the operational state 415-c. For example, the first network node may refrain from performing energy harvesting (e.g., skip a periodic or aperiodic energy harvesting occasion) while the BWP switching delay timer is active.

In some other cases, the first network node may extend the BWP switching delay timer, for example, by a delta value 430-b. The extended BWP switching delay timer may include time for the first network node to perform BWP switching, time switching between information communication (e.g., data reception) and energy harvesting, energy harvesting, time switching between energy harvesting and information communication, or any combination thereof. In some cases, the delta value 430-b may include an additional time gap configured by the network, negotiated between the UE 115 and the network, or both. The additional time gap may depend on a band (e.g., for data communications, for energy harvesting), a band combination, a BWP (e.g., for data communications, for energy harvesting), a BWP combination, a CC (e.g., for data communications, for energy harvesting), a CC combination, or any combination thereof. The first network node may add the delta value 430-b to the configured duration 435 of the BWP switching delay timer based on the overlap.

In some cases, network nodes may implement similar timelines for uplink BWP switching, for example, if a network node (e.g., a UE 115) fails to support transmitting uplink signals concurrent to an operational state (e.g., an energy harvesting duration).

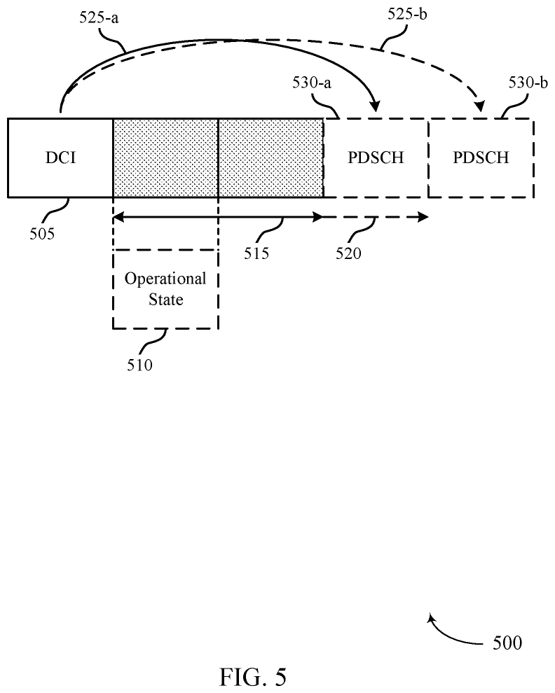

FIG. 5 shows an example of a DCI event 500 that supports timing modifications for devices based on operational states in accordance with one or more aspects of the present disclosure. A first network node (e.g., a network entity 105) may transmit DCI 505 to a second network node (e.g., a UE 115) in a wireless communications system, such as a wireless communications system 100 or a wireless communications system 300 as described herein with reference to FIGS. 1 and 3. The DCI 505 may trigger a BWP switch for the second network node. For example, the DCI 505 may schedule the second network node to communicate (e.g., receive downlink signaling, transmit uplink signaling) in a later resource via a different BWP. The DCI 505 may indicate a gap between the DCI 505 reception and the scheduled communications, where the gap allows the second network node to switch to the indicated BWP for the communications. However, in some cases, the second network node may operate according to an operational state 510 (e.g., an energy harvesting duration) during this gap. If the second network node fails to support the operational state 510 concurrent with the BWP switch, the second network node may adjust timing for the DCI-triggered BWP switch, the operational state 510, or both. In some cases, the first network node may configure the DCI 505 to indicate how the second network node accounts for the overlap between the operational state 510 and the DCI-triggered BWP switch (e.g., a BWP switching delay timer 515).

The first network node (e.g., a network entity 105 or base station) may configure the second network node (e.g., a UE 115) to modify timing information via L1 signaling, L2 signaling, L3 signaling, or some combination thereof. For example, if operational state 510 corresponds to an energy harvesting duration and the network configures or controls the energy harvesting, the first network node may adjust the energy harvesting duration based on the DCI-triggered BWP switch. For example, the first network node may increase the energy harvesting duration, decrease the energy harvesting duration, or cancel the energy harvesting duration. In some cases, the first network node may cancel the energy harvesting duration to avoid modifying the DCI 505 timing. For example, the DCI 505 may include an indication 525-a of a resource for PDSCH reception 530-a. The indication 525-a may support a gap between the DCI 505 reception and the PDSCH reception 530-a that is long enough for the second network node to perform BWP switching (e.g., according to a BWP switching delay timer 515). If the operational state 510 is canceled, the first network node may refrain from modifying the timing of the indication 525-a in the DCI 505.

Additionally, or alternatively, the first network node may adjust the timing of the DCI 505 based on the overlapping operational state 510. For example, the first network node may configure the DCI 505 with an indication 525-b of a resource for PDSCH reception 530-b that accounts for the operational state 510. The indication 525-b may support a gap between the DCI 505 reception and the PDSCH reception 530-b that is long enough for the second network node to perform BWP switching (e.g., according to a BWP switching delay timer 515 and a delta value 520 based on the duration of the operational state 510). In some cases, the first network node may indicate the delta value 520 (e.g., an additional timer or timer extension) in the DCI 505 based on the duration of the operational state 510. The first network node may determine the duration of the operational state 510 based on configuring the operational state 510 (e.g., configuring an energy harvesting cycle, duration, or both) or negotiating the operational state 510 with the second network node. The first network node may support a scheduling DCI that triggers BWP switching, a non-scheduling DCI that triggers BWP switching, or both. The scheduling DCI, non-scheduling DCI, or both may modify one or more timers (e.g., the BWP switching delay timer 515), modify the operational state 510 (e.g., cancel or adjust the duration of an energy harvesting operation), or both.

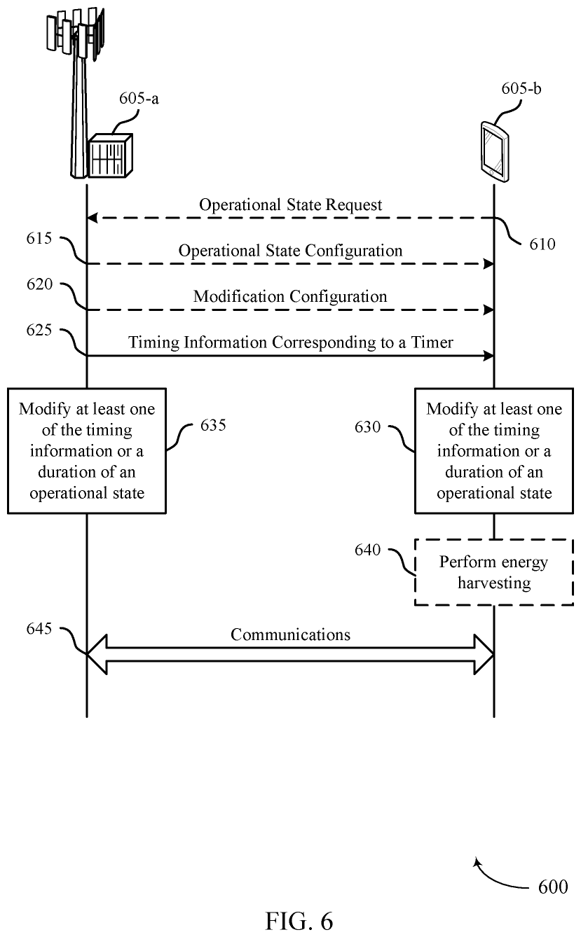

FIG. 6 shows an example of a process flow 600 that supports timing modifications for devices based on operational states in accordance with one or more aspects of the present disclosure. In some aspects, the process flow 600 may be implemented by aspects of the wireless communications system 100, the network architecture 200, the wireless communications system 300, or any combination thereof. For example, the process flow 600 may include a first network node 605-a and a second network node 605-b, which may be respective examples of a network entity 105 and a UE 115 as described herein with reference to FIGS. 1 through 5. The network entity 105 may be an example of a CU, a DU, an RU, a core network entity, or any combination thereof. In the following description of the process flow 600, the operations between the devices may be performed in different orders or at different times. Some operations may be left out of the process flow 600, or other operations may be added. Although the network node 605-a and the network node 605-b are shown performing the operations of the process flow 600, some aspects of some operations may be performed by one or more other devices.

In some cases, at 610, the second network node 605-b (e.g., a UE 115) may transmit an operational state request to the first network node 605-a (e.g., a network entity 105). For example, the first network node 605-a and the second network node 605-b may negotiate an operational state (e.g., energy harvesting, a low power mode) for the second network node 605-b. During a wake-up process, the first network node 605-a may transmit a wake-up signal to the second network node 605-b, and the second network node 605-b may transmit a wake-up signal response to the first network node 605-a. In some cases, the wake-up signal response may include a request for a specific delta value to modify timing based on the operational state. Additionally, or alternatively, the operational state request may request any modification to timing information. The operational state request may indicate a duration of the operational state for the second network node 605-b, a modified duration of the operational state for the second network node 605-b, or both. The signal including the operational state request may be an example of an energy report, an SR, a HARQ signal, a BSR, a RACH signal, UCI, or any combination thereof. In some cases, the second network node 605-b may backscatter the signal based on a power availability of the second network node 605-b.

In some cases, at 615, the first network node 605-a may transmit an operational state configuration for the second network node 605-b. The operational state configuration may configure a duration of the operational state (e.g., an energy harvesting duration) for the second network node 605-b, a periodicity of the operational state for the second network node 605-b, or both.

In some cases, at 620, the first network node 605-a may transmit a modification configuration for the second network node 605-b. The modification configuration may indicate to cancel the duration of the operational state for the second network node 605-b if there is an overlap in time of a timer duration and the duration of the operational state. In some cases, the modification configuration may configure a delta value for modifying a timer duration, the operational state duration, or both. In some aspects, the modification configuration may configure multiple delta values for the second network node 605-b, and the second network node 605-b may select a specific delta value from the multiple configured delta values based on the operational state. The signal including the modification configuration may be an example of a DCI signal, a MAC-CE, an RRC signal, a wake-up signal, or some combination thereof.

At 625, the first network node 605-a may transmit, for the second network node 605-b, timing information corresponding to a timer. The second network node 605-b may receive the timing information corresponding to the timer. The timer may be an example of a BWP inactivity timer, a BWP switching delay timer, an SSSG switching timer, an SCell deactivation timer, a DRX inactivity timer, a short DRX timer, or a long DRX timer. In some cases, the first network node 605-a may configure multiple timers for the second network node 605-b.

At 630, the second network node 605-b may modify at least one of the timing information or a duration of the operational state. For example, the second network node 605-b may perform the modification based on an overlap in time of a duration of the timer and the duration of the operational state for the second network node 605-b. Modifying the timing information may involve the second network node 605-b increasing the duration of the timer, decreasing the duration of the timer, canceling the timer, or pausing the timer. Additionally, or alternatively, modifying the duration of the operational state may involve the second network node 605-b decreasing the duration of the operational state for the second network node 605-b or canceling the duration of the operational state for the second network node 605-b. The second network node 605-b may modify the timing information, the duration of the operational state, or both based on the operational state request, the modification configuration, or both.

At 635, the first network node 605-a may perform a similar modification, for example, to align timing between the first network node 605-a and the second network node 605-b. The first network node 605-a may modify, based on the overlap in time of the duration of the timer and the duration of the operational state for the second network node 605-b, at least one of the timing information or the duration of the operational state.

In some cases, at 640, the second network node 605-b may perform an energy harvesting procedure during at least a portion of the duration of the operational state (e.g., if the operational state involves energy harvesting). For example, if the second network node 605-b does not cancel an energy harvesting duration, the second network node 605-b may perform energy harvesting during the energy harvesting duration.

At 645, the first network node 605-a and the second network node 605-b may communicate in accordance with the modified timing information or the modified duration of the operational state. For example, the communicating may involve the first network node 605-a transmitting DCI, transmitting downlink data, receiving UCI, receiving uplink data, or any combination thereof. The communicating may involve the second network node 605-b receiving DCI, receiving downlink data, transmitting UCI, transmitting uplink data, or any combination thereof.

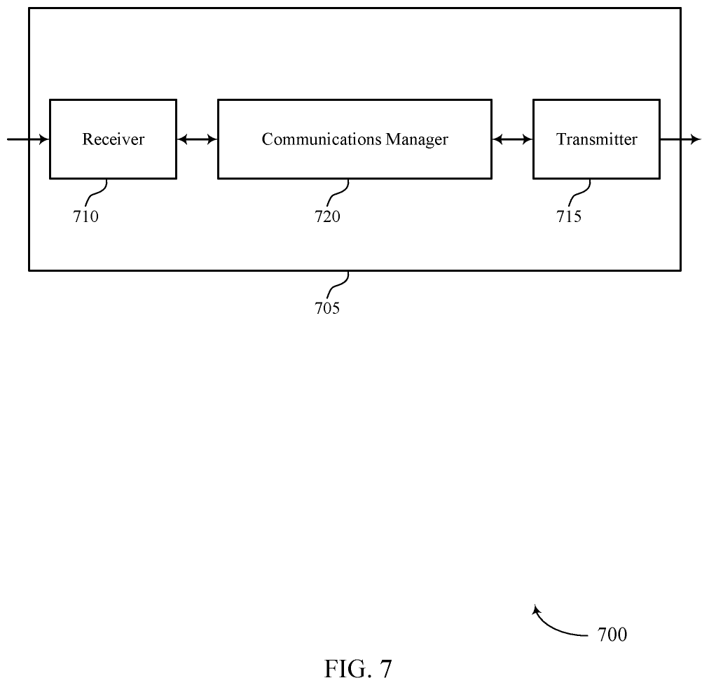

FIG. 7 shows a block diagram 700 of a device 705 that supports timing modifications for devices based on operational states in accordance with one or more aspects of the present disclosure. The device 705 may be an example of aspects of a network node, a UE 115, or both as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to timing modifications for devices based on operational states). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to timing modifications for devices based on operational states). In some aspects, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of timing modifications for devices based on operational states as described herein. For example, the communications manager 720, the receiver 710, the transmitter 715, or various combinations or components thereof may support a method for performing one or more of the functions described herein.

In some aspects, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a first network node in accordance with examples as disclosed herein. For example, the communications manager 720 may be configured as or otherwise support a means for receiving, from a second network node, timing information corresponding to a timer. The communications manager 720 may be configured as or otherwise support a means for modifying, based on an overlap in time of a duration of the timer and a duration of an operational state for the first network node, at least one of the timing information or the duration of the operational state. The communications manager 720 may be configured as or otherwise support a means for communicating with the second network node in accordance with the modified timing information or the modified duration of the operational state.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced power consumption, improved energy harvesting, or both. For example, the device 705 may operate according to an operational state that involves reducing a processing overhead, harvesting energy, or both. The device 705 may maintain timing alignment, improve communication timing, or both based on modifying timing in accordance with the operational state.

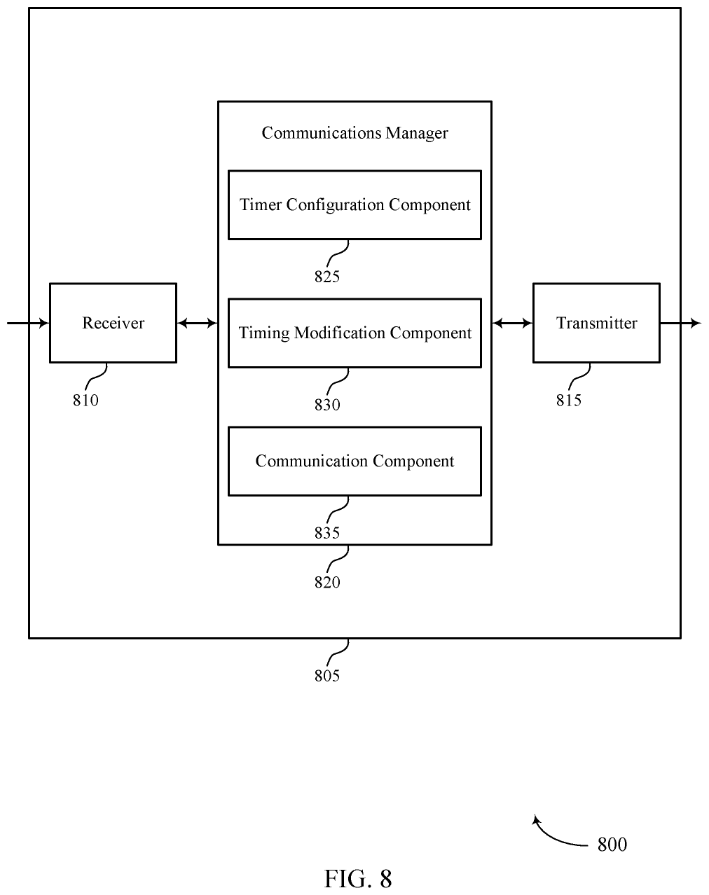

FIG. 8 shows a block diagram 800 of a device 805 that supports timing modifications for devices based on operational states in accordance with one or more aspects of the present disclosure. The device 805 may be an example of aspects of a network node, a device 705, or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to timing modifications for devices based on operational states). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to timing modifications for devices based on operational states). In some aspects, the transmitter 815 may be co-located with a receiver 810 in a transceiver module. The transmitter 815 may utilize a single antenna or a set of multiple antennas.

The device 805, or various components thereof, may be an example of means for performing various aspects of timing modifications for devices based on operational states as described herein. For example, the communications manager 820 may include a timer configuration component 825, a timing modification component 830, a communication component 835, or any combination thereof. The communications manager 820 may be an example of aspects of a communications manager 720 as described herein. In some aspects, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a first network node in accordance with examples as disclosed herein. The timer configuration component 825 may be configured as or otherwise support a means for receiving, from a second network node, timing information corresponding to a timer. The timing modification component 830 may be configured as or otherwise support a means for modifying, based on an overlap in time of a duration of the timer and a duration of an operational state for the first network node, at least one of the timing information or the duration of the operational state. The communication component 835 may be configured as or otherwise support a means for communicating with the second network node in accordance with the modified timing information or the modified duration of the operational state.

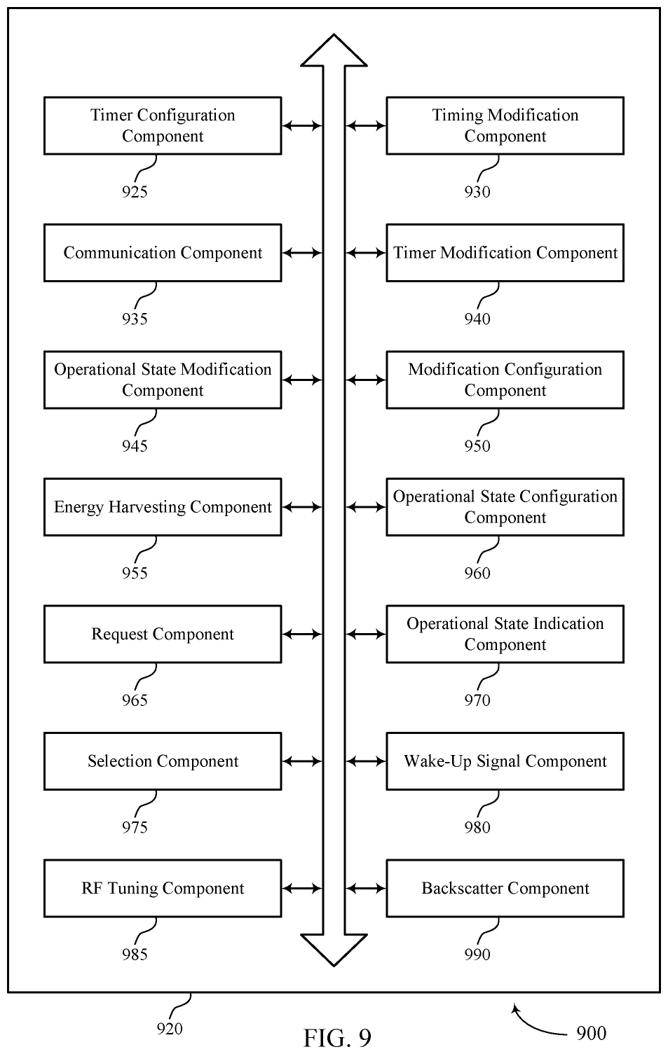

FIG. 9 shows a block diagram 900 of a communications manager 920 that supports timing modifications for devices based on operational states in accordance with one or more aspects of the present disclosure. The communications manager 920 may be an example of aspects of a communications manager 720, a communications manager 820, or both, as described herein. The communications manager 920, or various components thereof, may be an example of means for performing various aspects of timing modifications for devices based on operational states as described herein. For example, the communications manager 920 may include a timer configuration component 925, a timing modification component 930, a communication component 935, a timer modification component 940, an operational state modification component 945, a modification configuration component 950, an energy harvesting component 955, an operational state configuration component 960, a request component 965, an operational state indication component 970, a selection component 975, a wake-up signal component 980, an RF tuning component 985, a backscatter component 990, or any combination thereof. Each of these components may communicate, directly or indirectly, with one another (e.g., via one or more buses).

The communications manager 920 may support wireless communications at a first network node in accordance with examples as disclosed herein. The timer configuration component 925 may be configured as or otherwise support a means for receiving, from a second network node, timing information corresponding to a timer. The timing modification component 930 may be configured as or otherwise support a means for modifying, based on an overlap in time of a duration of the timer and a duration of an operational state for the first network node, at least one of the timing information or the duration of the operational state. The communication component 935 may be configured as or otherwise support a means for communicating with the second network node in accordance with the modified timing information or the modified duration of the operational state.

In some aspects, the timer modification component 940 may be configured as or otherwise support a means for increasing, based on the modified timing information, the duration of the timer. In some aspects, the timer modification component 940 may be configured as or otherwise support a means for decreasing, based on the modified timing information, the duration of the timer. In some aspects, the timer modification component 940 may be configured as or otherwise support a means for canceling, based on the modified timing information, the duration of the timer. In some aspects, the timer modification component 940 may be configured as or otherwise support a means for pausing, based on the modified timing information, the timer. In some aspects, the timer includes a BWP inactivity timer, a BWP switching delay timer, an SSSG switching timer, an SCell deactivation timer, a DRX inactivity timer, a short DRX timer, or a long DRX timer.

In some aspects, to support modifying the duration of the operational state, the operational state modification component 945 may be configured as or otherwise support a means for decreasing the duration of the operational state for the first network node. In some other aspects, to support modifying the duration of the operational state, the operational state modification component 945 may be configured as or otherwise support a means for canceling the duration of the operational state for the first network node.

In some aspects, the modification configuration component 950 may be configured as or otherwise support a means for receiving, from the second network node, a signal that indicates to cancel the duration of the operational state for the first network node based on the overlap in time of the duration of the timer and the duration of the operational state for the first network node, where the duration of the operational state for the first network node is canceled further based on the signal.

In some aspects, the modification configuration component 950 may be configured as or otherwise support a means for receiving, from the second network node, a signal that configures a first delta value for the first network node. In some aspects, to modify at least one of the timing information or the duration of the operational state, the timing modification component 930 may be configured to modify the duration of the timer or the duration of the operational state based on the first delta value. In some aspects, the signal configures a set of multiple delta values including at least the first delta value, and the selection component 975 may be configured as or otherwise support a means for selecting the first delta value from the set of multiple delta values based on the operational state for the first network node, where the operational state for the first network node is based on the duration of the operational state including an energy harvesting duration for the first network node, based on an energy availability for radio frequency tuning for the first network node, or both. In some aspects, the signal includes DCI, a MAC-CE, an RRC signal, or a wake-up signal. In some aspects, the wake-up signal component 980 may be configured as or otherwise support a means for transmitting, to the second network node, a wake-up signal response that includes a request for a second delta value for the first network node, where the signal that configures the first delta value is received based on the request.

In some aspects, the energy harvesting component 955 may be configured as or otherwise support a means for performing an energy harvesting procedure during at least a portion of the duration (e.g., a modified duration) of the operational state. In some aspects, the modified duration of the operational state includes a first portion during which a first switch from a communication mode to an energy harvesting mode is configured to occur, a second portion during which the energy harvesting procedure is configured to occur, and a third portion during which a second switch from the energy harvesting mode to the communication mode is configured to occur, where the portion of the modified duration of the operational state includes the second portion.

In some aspects, the RF tuning component 985 may be configured as or otherwise support a means for performing first RF tuning from a first frequency band for communication to a second frequency band for the energy harvesting procedure. In some aspects, the RF tuning component 985 may be configured as or otherwise support a means for performing second RF tuning from the second frequency band for the energy harvesting procedure to the first frequency band for the communication, where the modified duration of the operational state for the first network node further includes the first RF tuning and the second RF tuning.

In some aspects, to support modifying at least one of the timing information or the duration of the operational state, the timing modification component 930 may be configured as or otherwise support a means for modifying at least one of the timing information or the duration of the operational state based on a type of the energy harvesting procedure, where the type of the energy harvesting procedure includes RF energy harvesting, solar energy harvesting, thermal energy harvesting, vibrational energy harvesting, or laser energy harvesting.

In some aspects, to support modifying at least one of the timing information or the duration of the operational state, the timing modification component 930 may be configured as or otherwise support a means for modifying at least one of the timing information or the duration of the operational state based on a capability of the first network node to perform an RF tuning procedure to a new BWP concurrent to the energy harvesting procedure.

In some aspects, the operational state configuration component 960 may be configured as or otherwise support a means for receiving, from the second network node, a signal that configures the duration of the operational state for the first network node. In some aspects, the signal configures a periodicity for a set of multiple durations of the operational state for the first network node.

In some aspects, the request component 965 may be configured as or otherwise support a means for transmitting, to the second network node, a request for a modification to the timing information. In some aspects, the modification configuration component 950 may be configured as or otherwise support a means for receiving, from the second network node and based on the request, an indication of the modification to the timing information, where, to modify the timing information, the timing modification component 930 may be configured to modify the timing information based on the indication of the modification to the timing information. In some aspects, the indication of the modification to the timing information includes a lookup table, a lookup table index, a codepoint, a value, or any combination thereof.

In some aspects, the operational state indication component 970 may be configured as or otherwise support a means for transmitting, to the second network node, a signal that includes a first indication of the duration of the operational state for the first network node, a second indication of the modified duration of the operational state, or both, where the communication with the second network node is based on the first indication of the duration of the operational state, the second indication of the modified duration of the operational state, or both. In some aspects, the signal includes an energy report, an SR, a HARQ signal, a BSR, a RACH signal, a UCI signal, or any combination thereof. In some aspects, to support transmitting the signal, the backscatter component 990 may be configured as or otherwise support a means for backscattering the signal based on a power availability of the first network node.

In some aspects, the first network node is unavailable to communicate information with the second network node during the modified duration of the operational state.

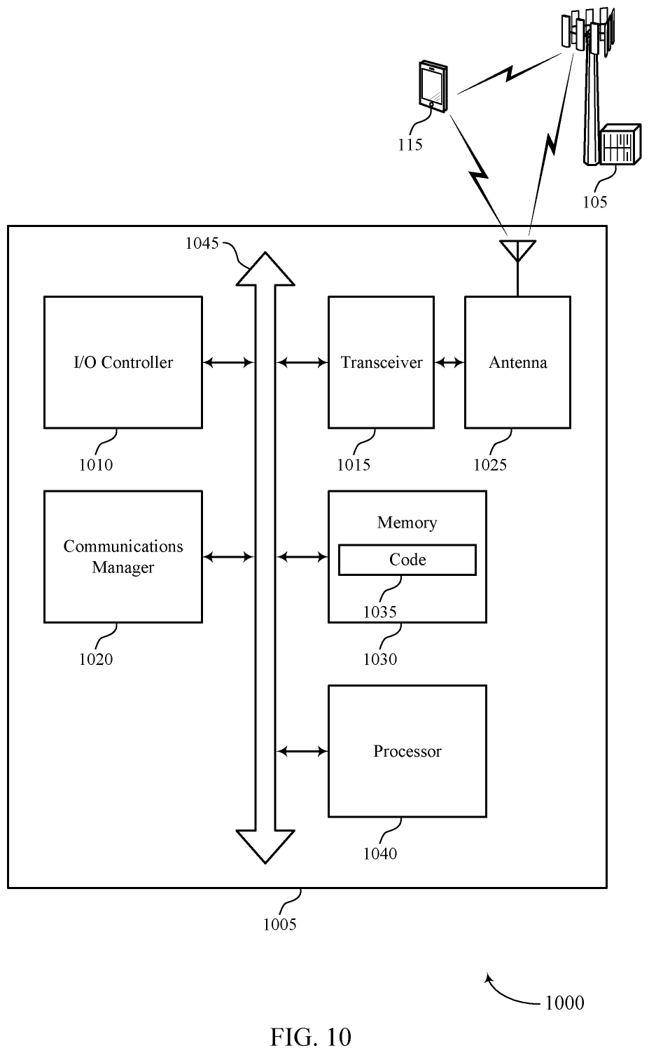

FIG. 10 shows a diagram of a system 1000 including a device 1005 that supports timing modifications for devices based on operational states in accordance with one or more aspects of the present disclosure. The device 1005 may be an example of or include the components of a device 705, a device 805, a network node, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting timing modifications for devices based on operational states). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a first network node in accordance with examples as disclosed herein. For example, the communications manager 1020 may be configured as or otherwise support a means for receiving, from a second network node, timing information corresponding to a timer. The communications manager 1020 may be configured as or otherwise support a means for modifying, based on an overlap in time of a duration of the timer and a duration of an operational state for the first network node, at least one of the timing information or the duration of the operational state. The communications manager 1020 may be configured as or otherwise support a means for communicating with the second network node in accordance with the modified timing information or the modified duration of the operational state.

By including or configuring the communications manager 1020 in accordance with examples as described herein, the device 1005 may support techniques for improved communication reliability, reduced power consumption, more efficient utilization of communication resources, improved coordination between devices, longer battery life, and improved utilization of processing capability). For example, by supporting the operational state at the device 1005, the device 1005 may support energy harvesting procedures, a low power mode, or both. The device 1005 may coordinate timing between such operational states and timers at the device 1005, improving the reliability of timer operation and corresponding communications at the device 1005.

In some aspects, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some aspects, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of timing modifications for devices based on operational states as described herein, or the processor 1040 and the memory 1030 may be otherwise configured to perform or support such operations.

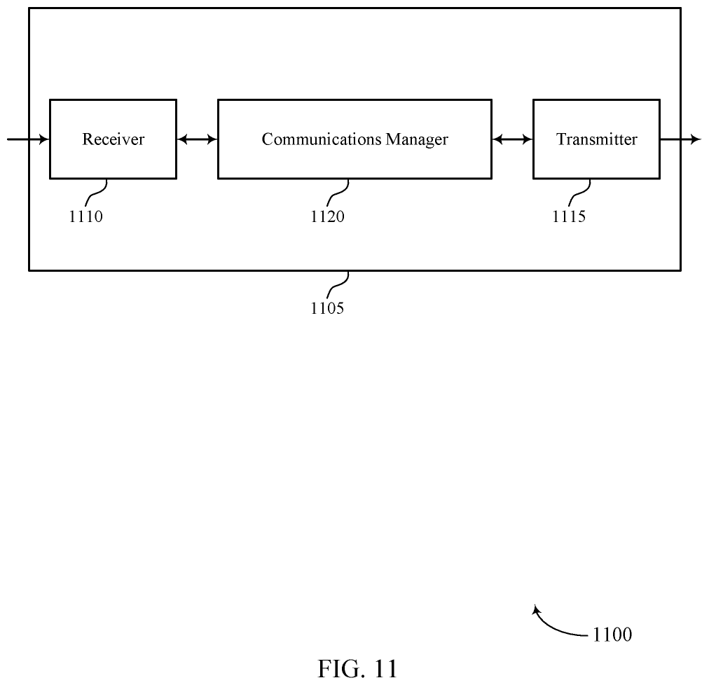

FIG. 11 shows a block diagram 1100 of a device 1105 that supports timing modifications for devices based on operational states in accordance with one or more aspects of the present disclosure. The device 1105 may be an example of aspects of a network node, a network entity 105, or both as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some aspects, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some aspects, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of timing modifications for devices based on operational states as described herein. For example, the communications manager 1120, the receiver 1110, the transmitter 1115, or various combinations or components thereof may support a method for performing one or more of the functions described herein.

In some aspects, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a first network node in accordance with examples as disclosed herein. For example, the communications manager 1120 may be configured as or otherwise support a means for transmitting, for a second network node, timing information corresponding to a timer. The communications manager 1120 may be configured as or otherwise support a means for modifying, based on an overlap in time of a duration of the timer and a duration of an operational state for the second network node, at least one of the timing information or the duration of the operational state. The communications manager 1120 may be configured as or otherwise support a means for communicating with the second network node in accordance with the modified timing information or the modified duration of the operational state.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for improved coordination between devices. For example, the device 1105 may coordinate timing with another device (e.g., a UE 115) performing energy harvesting, improving communication reliability and timing alignment.

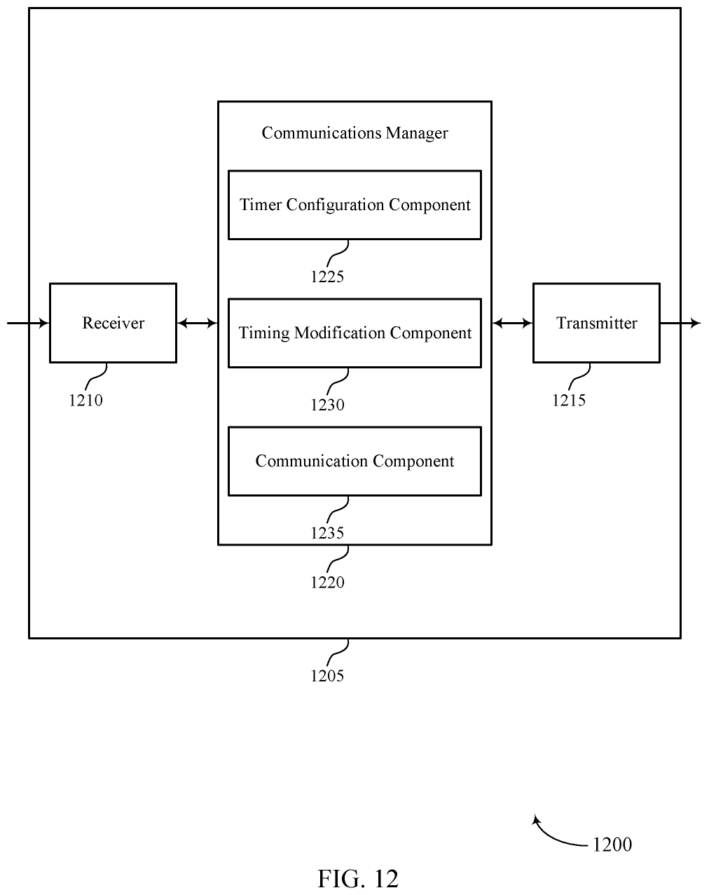

FIG. 12 shows a block diagram 1200 of a device 1205 that supports timing modifications for devices based on operational states in accordance with one or more aspects of the present disclosure. The device 1205 may be an example of aspects of a network node, a device 1105, or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some aspects, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some aspects, the transmitter 1215 and the receiver 1210 may be co-located in a transceiver, which may include or be coupled with a modem.

The device 1205, or various components thereof, may be an example of means for performing various aspects of timing modifications for devices based on operational states as described herein. For example, the communications manager 1220 may include a timer configuration component 1225, a timing modification component 1230, a communication component 1235, or any combination thereof. The communications manager 1220 may be an example of aspects of a communications manager 1120 as described herein. In some aspects, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a first network node in accordance with examples as disclosed herein. The timer configuration component 1225 may be configured as or otherwise support a means for transmitting, for a second network node, timing information corresponding to a timer. The timing modification component 1230 may be configured as or otherwise support a means for modifying, based on an overlap in time of a duration of the timer and a duration of an operational state for the second network node, at least one of the timing information or the duration of the operational state. The communication component 1235 may be configured as or otherwise support a means for communicating with the second network node in accordance with the modified timing information or the modified duration of the operational state.

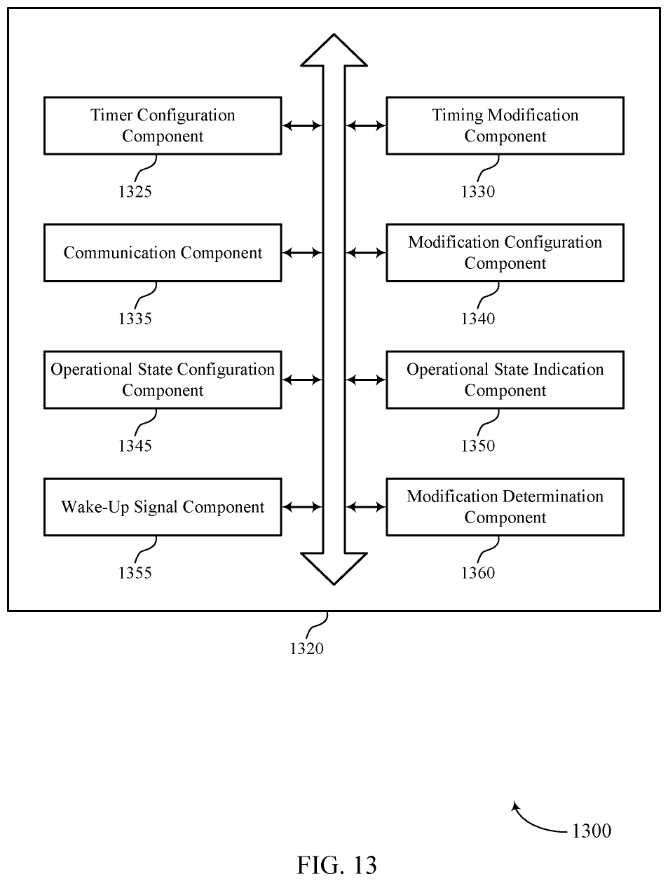

FIG. 13 shows a block diagram 1300 of a communications manager 1320 that supports timing modifications for devices based on operational states in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of timing modifications for devices based on operational states as described herein. For example, the communications manager 1320 may include a timer configuration component 1325, a timing modification component 1330, a communication component 1335, a modification configuration component 1340, an operational state configuration component 1345, an operational state indication component 1350, a wake-up signal component 1355, a modification determination component 1360, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a first network node in accordance with examples as disclosed herein. The timer configuration component 1325 may be configured as or otherwise support a means for transmitting, for a second network node, timing information corresponding to a timer. The timing modification component 1330 may be configured as or otherwise support a means for modifying, based on an overlap in time of a duration of the timer and a duration of an operational state for the second network node, at least one of the timing information or the duration of the operational state. The communication component 1335 may be configured as or otherwise support a means for communicating with the second network node in accordance with the modified timing information or the modified duration of the operational state.

In some aspects, the modification configuration component 1340 may be configured as or otherwise support a means for transmitting, for the second network node, a signal that configures a first delta value for the second network node, where, to modify at least one of the timing information or the duration of the operational state, the timing modification component 1330 may be configured to modify the duration of the timer or the duration of the operational state based on the first delta value.

In some aspects, the wake-up signal component 1355 may be configured as or otherwise support a means for receiving, for the second network node, a wake-up signal response that includes a request for a second delta value for the second network node. In some aspects, the modification determination component 1360 may be configured as or otherwise support a means for determining the first delta value based on the request.

In some aspects, the timer includes a BWP inactivity timer, a BWP switching delay timer, an SSSG switching timer, an SCell deactivation timer, a DRX inactivity timer, a short DRX timer, or a long DRX timer.

In some aspects, the operational state configuration component 1345 may be configured as or otherwise support a means for transmitting, for the second network node, a signal that configures the duration of the operational state for the second network node.

In some aspects, the operational state indication component 1350 may be configured as or otherwise support a means for receiving, for the second network node, a signal that includes a first indication of the duration of the operational state for the second network node, a second indication of the modified duration of the operational state, or both, where the communication with the second network node is based on the first indication of the duration of the operational state, the second indication of the modified duration of the operational state, or both.

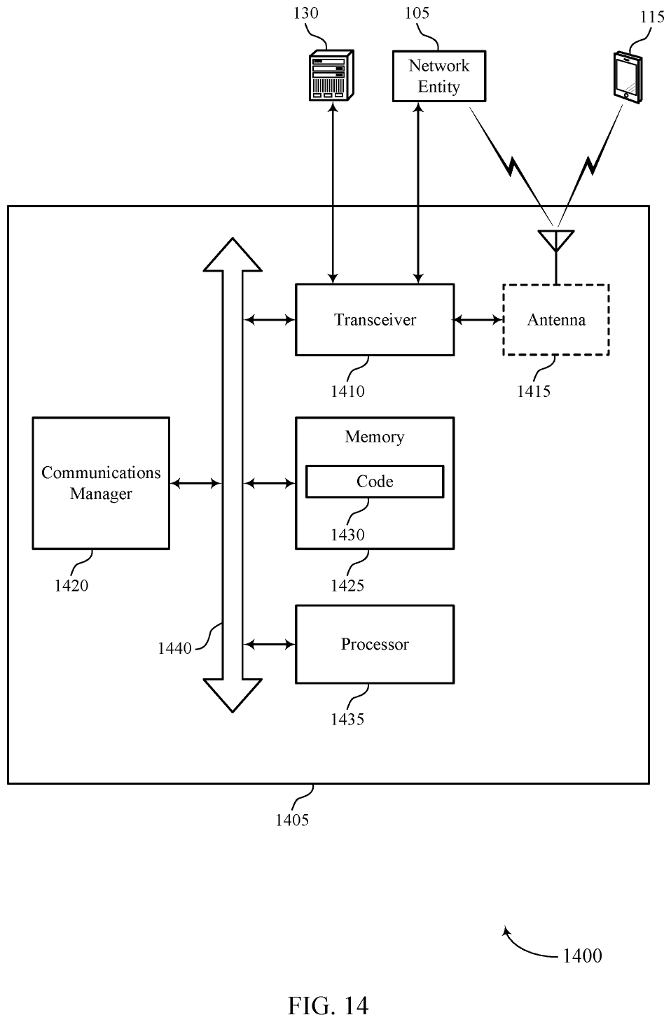

FIG. 14 shows a diagram of a system 1400 including a device 1405 that supports timing modifications for devices based on operational states in accordance with one or more aspects of the present disclosure. The device 1405 may be an example of or include the components of a device 1105, a device 1205, a network node, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some aspects, the transceiver 1410 may include a wired transceiver and may communicate bi-directionally with another wired transceiver. Additionally, or alternatively, in some aspects, the transceiver 1410 may include a wireless transceiver and may communicate bi-directionally with another wireless transceiver. In some aspects, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some aspects, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting timing modifications for devices based on operational states). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405 and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some aspects, a bus 1440 may support communications of (e.g., within) a protocol layer of a protocol stack. In some aspects, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some aspects, the communications manager 1420 may manage aspects of communications with a core network 130 (e.g., via one or more wired or wireless backhaul links). For example, the communications manager 1420 may manage the transfer of data communications for client devices, such as one or more UEs 115. In some aspects, the communications manager 1420 may manage communications with other network entities 105 and may include a controller or scheduler for controlling communications with UEs 115 in cooperation with other network entities 105. In some aspects, the communications manager 1420 may support an X2 interface within an LTE/LTE-A wireless communications network technology to provide communication between network entities 105.

The communications manager 1420 may support wireless communications at a first network node in accordance with examples as disclosed herein. For example, the communications manager 1420 may be configured as or otherwise support a means for transmitting, for a second network node, timing information corresponding to a timer. The communications manager 1420 may be configured as or otherwise support a means for modifying, based on an overlap in time of a duration of the timer and a duration of an operational state for the second network node, at least one of the timing information or the duration of the operational state. The communications manager 1420 may be configured as or otherwise support a means for communicating with the second network node in accordance with the modified timing information or the modified duration of the operational state.

In some aspects, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some aspects, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of timing modifications for devices based on operational states as described herein, or the processor 1435 and the memory 1425 may be otherwise configured to perform or support such operations.

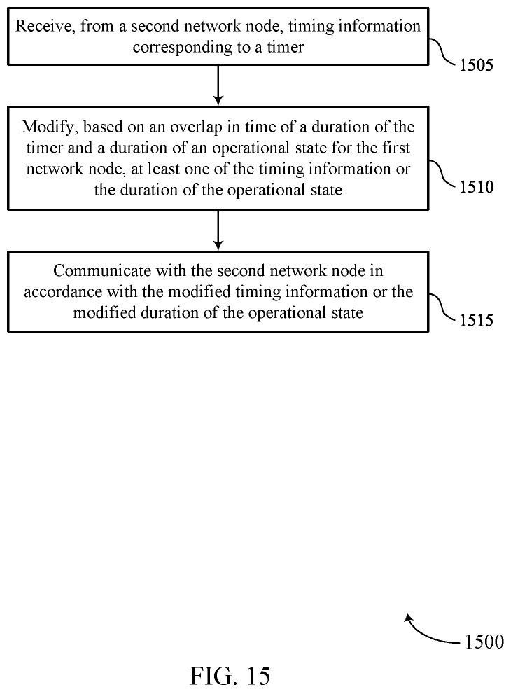

FIG. 15 shows a flowchart illustrating a method 1500 that supports timing modifications for devices based on operational states in accordance with one or more aspects of the present disclosure. The operations of the method 1500 may be implemented by a first network node or its components as described herein. For example, the operations of the method 1500 may be performed by a UE 115 as described with reference to FIGS. 1 through 10. In some aspects, a UE may execute a set of instructions to control the functional elements of the UE to perform the described functions. Additionally, or alternatively, the UE may perform aspects of the described functions using special-purpose hardware.

At 1505, the method may include receiving, from a second network node, timing information corresponding to a timer. The operations of 1505 may be performed in accordance with examples as disclosed herein. In some aspects, aspects of the operations of 1505 may be performed by a timer configuration component 925 as described with reference to FIG. 9.

At 1510, the method may include modifying, based on an overlap in time of a duration of the timer and a duration of an operational state for the first network node, at least one of the timing information or the duration of the operational state. The operations of 1510 may be performed in accordance with examples as disclosed herein. In some aspects, aspects of the operations of 1510 may be performed by a timing modification component 930 as described with reference to FIG. 9.

At 1515, the method may include communicating with the second network node in accordance with the modified timing information or the modified duration of the operational state. The operations of 1515 may be performed in accordance with examples as disclosed herein. In some aspects, aspects of the operations of 1515 may be performed by a communication component 935 as described with reference to FIG. 9.

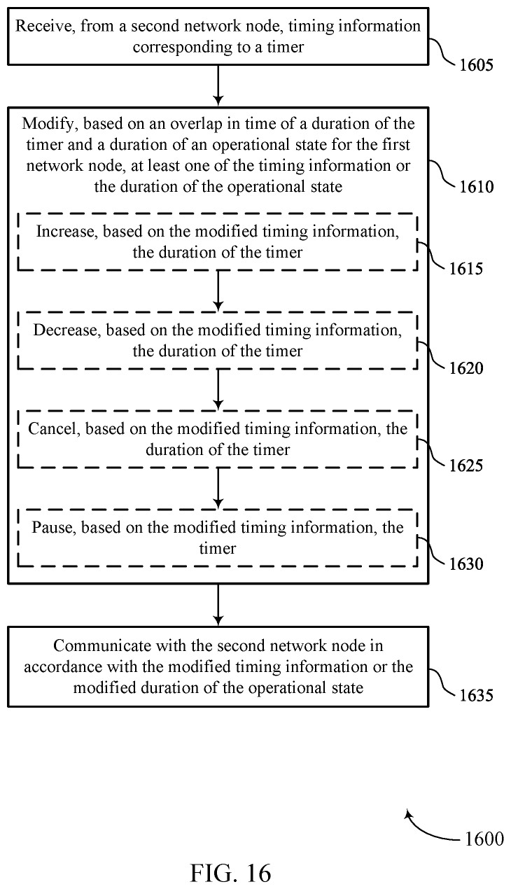

FIG. 16 shows a flowchart illustrating a method 1600 that supports timing modifications for devices based on operational states in accordance with one or more aspects of the present disclosure. The operations of the method 1600 may be implemented by a first network node or its components as described herein. For example, the operations of the method 1600 may be performed by a UE 115 as described with reference to FIGS. 1 through 10. In some aspects, a UE may execute a set of instructions to control the functional elements of the UE to perform the described functions. Additionally, or alternatively, the UE may perform aspects of the described functions using special-purpose hardware.

At 1605, the method may include receiving, from a second network node, timing information corresponding to a timer. The operations of 1605 may be performed in accordance with examples as disclosed herein. In some aspects, aspects of the operations of 1605 may be performed by a timer configuration component 925 as described with reference to FIG. 9.

At 1610, the method may include modifying, based on an overlap in time of a duration of the timer and a duration of an operational state for the first network node, at least one of the timing information or the duration of the operational state. The operations of 1610 may be performed in accordance with examples as disclosed herein. In some aspects, aspects of the operations of 1610 may be performed by a timing modification component 930 as described with reference to FIG. 9.

In some aspects, at 1615, the method may include increasing, based on the modified timing information, the duration of the timer. The operations of 1615 may be performed in accordance with examples as disclosed herein. In some aspects, aspects of the operations of 1615 may be performed by a timer modification component 940 as described with reference to FIG. 9.

In some aspects, at 1620, the method may include decreasing, based on the modified timing information, the duration of the timer. The operations of 1620 may be performed in accordance with examples as disclosed herein. In some aspects, aspects of the operations of 1620 may be performed by a timer modification component 940 as described with reference to FIG. 9.

In some aspects, at 1625, the method may include canceling, based on the modified timing information, the duration of the timer. The operations of 1625 may be performed in accordance with examples as disclosed herein. In some aspects, aspects of the operations of 1625 may be performed by a timer modification component 940 as described with reference to FIG. 9.

In some aspects, at 1630, the method may include pausing, based on the modified timing information, the timer. The operations of 1630 may be performed in accordance with examples as disclosed herein. In some aspects, aspects of the operations of 1630 may be performed by a timer modification component 940 as described with reference to FIG. 9.

At 1635, the method may include communicating with the second network node in accordance with the modified timing information or the modified duration of the operational state. The operations of 1635 may be performed in accordance with examples as disclosed herein. In some aspects, aspects of the operations of 1635 may be performed by a communication component 935 as described with reference to FIG. 9.

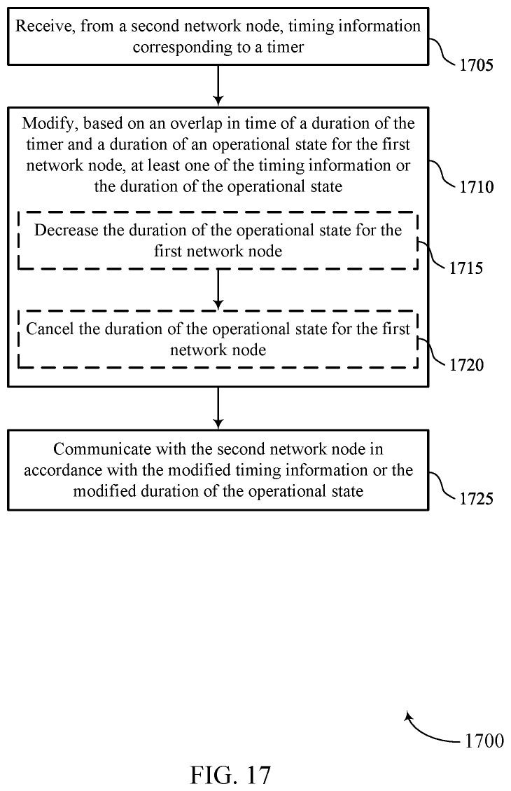

FIG. 17 shows a flowchart illustrating a method 1700 that supports timing modifications for devices based on operational states in accordance with one or more aspects of the present disclosure. The operations of the method 1700 may be implemented by a first network node or its components as described herein. For example, the operations of the method 1700 may be performed by a UE 115 as described with reference to FIGS. 1 through 10. In some aspects, a UE may execute a set of instructions to control the functional elements of the UE to perform the described functions. Additionally, or alternatively, the UE may perform aspects of the described functions using special-purpose hardware.

At 1705, the method may include receiving, from a second network node, timing information corresponding to a timer. The operations of 1705 may be performed in accordance with examples as disclosed herein. In some aspects, aspects of the operations of 1705 may be performed by a timer configuration component 925 as described with reference to FIG. 9.

At 1710, the method may include modifying, based on an overlap in time of a duration of the timer and a duration of an operational state for the first network node, at least one of the timing information or the duration of the operational state. The operations of 1710 may be performed in accordance with examples as disclosed herein. In some aspects, aspects of the operations of 1710 may be performed by a timing modification component 930 as described with reference to FIG. 9.

In some aspects, at 1715, the method may include decreasing the duration of the operational state for the first network node. The operations of 1715 may be performed in accordance with examples as disclosed herein. In some aspects, aspects of the operations of 1715 may be performed by an operational state modification component 945 as described with reference to FIG. 9.

In some aspects, at 1720, the method may include canceling the duration of the operational state for the first network node. The operations of 1720 may be performed in accordance with examples as disclosed herein. In some aspects, aspects of the operations of 1720 may be performed by an operational state modification component 945 as described with reference to FIG. 9.

At 1725, the method may include communicating with the second network node in accordance with the modified timing information or the modified duration of the operational state. The operations of 1725 may be performed in accordance with examples as disclosed herein. In some aspects, aspects of the operations of 1725 may be performed by a communication component 935 as described with reference to FIG. 9.

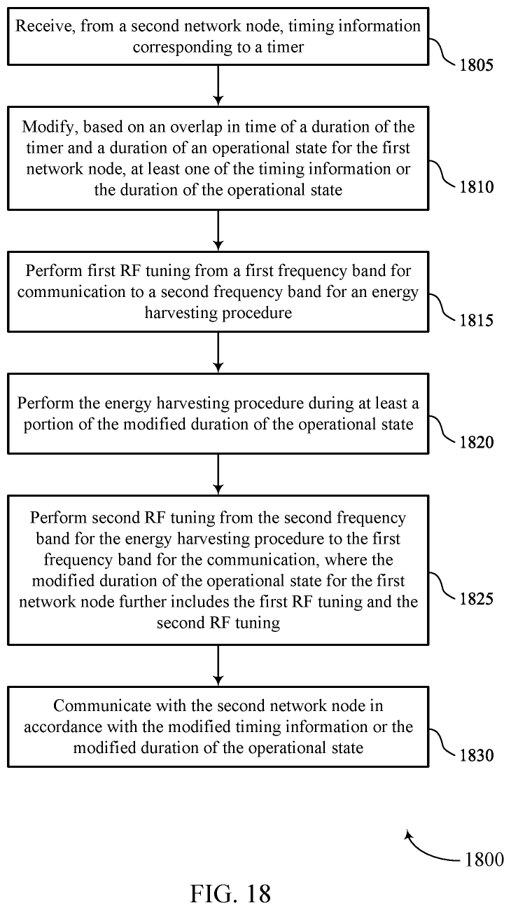

FIG. 18 shows a flowchart illustrating a method 1800 that supports timing modifications for devices based on operational states in accordance with one or more aspects of the present disclosure. The operations of the method 1800 may be implemented by a first network node or its components as described herein. For example, the operations of the method 1800 may be performed by a UE 115 as described with reference to FIGS. 1 through 10. In some aspects, a UE may execute a set of instructions to control the functional elements of the UE to perform the described functions. Additionally, or alternatively, the UE may perform aspects of the described functions using special-purpose hardware.

At 1805, the method may include receiving, from a second network node, timing information corresponding to a timer. The operations of 1805 may be performed in accordance with examples as disclosed herein. In some aspects, aspects of the operations of 1805 may be performed by a timer configuration component 925 as described with reference to FIG. 9.

At 1810, the method may include modifying, based on an overlap in time of a duration of the timer and a duration of an operational state for the first network node, at least one of the timing information or the duration of the operational state. The operations of 1810 may be performed in accordance with examples as disclosed herein. In some aspects, aspects of the operations of 1810 may be performed by a timing modification component 930 as described with reference to FIG. 9.

At 1815, the method may include performing first RF tuning from a first frequency band for communication to a second frequency band for an energy harvesting procedure. The operations of 1815 may be performed in accordance with examples as disclosed herein. In some aspects, aspects of the operations of 1815 may be performed by an RF tuning component 985 as described with reference to FIG. 9.

At 1820, the method may include performing the energy harvesting procedure during at least a portion of the modified duration of the operational state. The operations of 1820 may be performed in accordance with examples as disclosed herein. In some aspects, aspects of the operations of 1820 may be performed by an energy harvesting component 955 as described with reference to FIG. 9.

At 1825, the method may include performing second RF tuning from the second frequency band for the energy harvesting procedure to the first frequency band for the communication, where the modified duration of the operational state for the first network node further includes the first RF tuning and the second RF tuning. The operations of 1825 may be performed in accordance with examples as disclosed herein. In some aspects, aspects of the operations of 1825 may be performed by an RF tuning component 985 as described with reference to FIG. 9.

At 1830, the method may include communicating with the second network node in accordance with the modified timing information or the modified duration of the operational state. The operations of 1830 may be performed in accordance with examples as disclosed herein. In some aspects, aspects of the operations of 1830 may be performed by a communication component 935 as described with reference to FIG. 9.

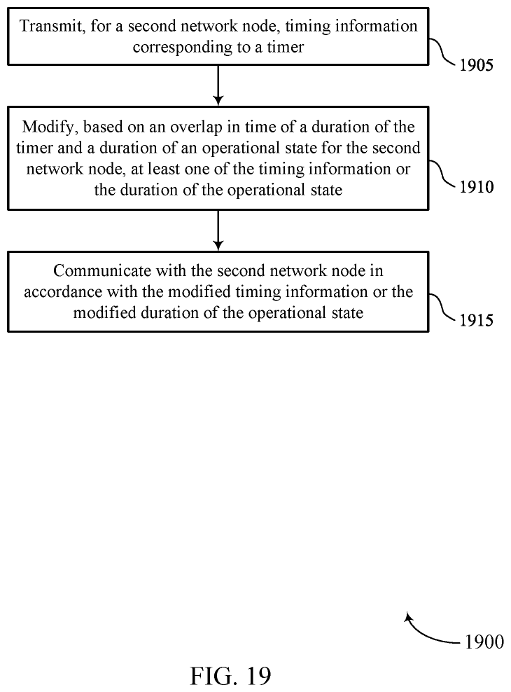

FIG. 19 shows a flowchart illustrating a method 1900 that supports timing modifications for devices based on operational states in accordance with one or more aspects of the present disclosure. The operations of the method 1900 may be implemented by a first network node or its components as described herein. For example, the operations of the method 1900 may be performed by a network entity as described with reference to FIGS. 1 through 6 and 11 through 14. In some aspects, a network entity may execute a set of instructions to control the functional elements of the network entity to perform the described functions. Additionally, or alternatively, the network entity may perform aspects of the described functions using special-purpose hardware.

At 1905, the method may include transmitting, for a second network node, timing information corresponding to a timer. The operations of 1905 may be performed in accordance with examples as disclosed herein. In some aspects, aspects of the operations of 1905 may be performed by a timer configuration component 1325 as described with reference to FIG. 13.

At 1910, the method may include modifying, based on an overlap in time of a duration of the timer and a duration of an operational state for the second network node, at least one of the timing information or the duration of the operational state. The operations of 1910 may be performed in accordance with examples as disclosed herein. In some aspects, aspects of the operations of 1910 may be performed by a timing modification component 1330 as described with reference to FIG. 13.

At 1915, the method may include communicating with the second network node in accordance with the modified timing information or the modified duration of the operational state. The operations of 1915 may be performed in accordance with examples as disclosed herein. In some aspects, aspects of the operations of 1915 may be performed by a communication component 1335 as described with reference to FIG. 13.

The following provides an overview of aspects of the present disclosure:

Aspect 1: A method of wireless communications performed by a first network node, comprising: receiving, from a second network node, timing information corresponding to a timer; modifying, based on an overlap in time of a duration of the timer and a duration of an operational state for the first network node, at least one of the timing information or the duration of the operational state; and communicating with the second network node in accordance with the modified timing information or the modified duration of the operational state.

Aspect 2: The method of aspect 1, further comprising: increasing, based on the modified timing information, the duration of the timer; decreasing, based on the modified timing information, the duration of the timer; canceling, based on the modified timing information, the duration of the timer; or pausing, based on the modified timing information, the timer.

Aspect 3: The method of any of aspects 1 through 2, wherein the timer comprises a bandwidth part inactivity timer, a bandwidth part switching delay timer, a search space set group switching timer, a secondary cell deactivation timer, a discontinuous reception inactivity timer, a short discontinuous reception timer, or a long discontinuous reception timer.

Aspect 4: The method of any of aspects 1 through 3, wherein modifying the duration of the operational state comprises: decreasing the duration of the operational state for the first network node.

Aspect 5: The method of any of aspects 1 through 3, wherein modifying the duration of the operational state comprises: canceling the duration of the operational state for the first network node.

Aspect 6: The method of aspect 5, further comprising: receiving, from the second network node, a signal that indicates to cancel the duration of the operational state for the first network node based on the overlap in time of the duration of the timer and the duration of the operational state for the first network node, wherein the duration of the operational state for the first network node is canceled further based on the signal.

Aspect 7: The method of any of aspects 1 through 6, further comprising: receiving, from the second network node, a signal that configures a first delta value for the first network node, wherein modifying at least one of the timing information or the duration of the operational state comprises modifying the duration of the timer or the duration of the operational state based on the first delta value.

Aspect 8: The method of aspect 7, wherein the signal configures a plurality of delta values comprising at least the first delta value, the method further comprising: selecting the first delta value from the plurality of delta values based on the operational state for the first network node, wherein the operational state for the first network node is based on the duration of the operational state comprising an energy harvesting duration for the first network node, based on an energy availability for radio frequency tuning for the first network node, or both.

Aspect 9: The method of any of aspects 7 through 8, wherein the signal comprises downlink control information, a medium access control element, a radio resource control signal, or a wake-up signal.

Aspect 10: The method of any of aspects 7 through 9, further comprising: transmitting, to the second network node, a wake-up signal response that comprises a request for a second delta value for the first network node, wherein the signal that configures the first delta value is received based on the request.

Aspect 11: The method of any of aspects 1 through 10, further comprising: performing an energy harvesting procedure during at least a portion of the modified duration of the operational state.

Aspect 12: The method of aspect 11, wherein the modified duration of the operational state comprises a first portion during which a first switch from a communication mode to an energy harvesting mode is configured to occur, a second portion during which the energy harvesting procedure is configured to occur, and a third portion during which a second switch from the energy harvesting mode to the communication mode is configured to occur, wherein the portion of the modified duration of the operational state includes the second portion.

Aspect 13: The method of any of aspects 11 through 12, further comprising: performing first radio frequency tuning from a first frequency band for communication to a second frequency band for the energy harvesting procedure; and performing second radio frequency tuning from the second frequency band for the energy harvesting procedure to the first frequency band for the communication, wherein the modified duration of the operational state for the first network node further comprises the first radio frequency tuning and the second radio frequency tuning.

Aspect 14: The method of any of aspects 11 through 13, wherein modifying at least one of the timing information or the duration of the operational state comprises: modifying at least one of the timing information or the duration of the operational state based on a type of the energy harvesting procedure, wherein the type of the energy harvesting procedure comprises radio frequency energy harvesting, solar energy harvesting, thermal energy harvesting, vibrational energy harvesting, or laser energy harvesting.

Aspect 15: The method of any of aspects 11 through 14, wherein modifying at least one of the timing information or the duration of the operational state comprises: modifying at least one of the timing information or the duration of the operational state based on a capability of the first network node to perform a radio frequency tuning procedure to a new bandwidth part concurrent to the energy harvesting procedure.

Aspect 16: The method of any of aspects 1 through 15, further comprising: receiving, from the second network node, a signal that configures the duration of the operational state for the first network node.

Aspect 17: The method of aspect 16, wherein the signal configures a periodicity for a plurality of durations of the operational state for the first network node.

Aspect 18: The method of any of aspects 1 through 17, further comprising: transmitting, to the second network node, a request for a modification to the timing information; and receiving, from the second network node and based on the request, an indication of the modification to the timing information, wherein modifying the timing information comprises modifying the timing information based on the indication of the modification to the timing information.

Aspect 19: The method of aspect 18, wherein the indication of the modification to the timing information comprises a lookup table, a lookup table index, a codepoint, a value, or any combination thereof.

Aspect 20: The method of any of aspects 1 through 19, further comprising: transmitting, to the second network node, a signal that comprises a first indication of the duration of the operational state for the first network node, a second indication of the modified duration of the operational state, or both, wherein the communication with the second network node is based on the first indication of the duration of the operational state, the second indication of the modified duration of the operational state, or both.

Aspect 21: The method of aspect 20, wherein the signal comprises an energy report, a scheduling request, a hybrid automatic repeat request signal, a buffer status report, a random access channel signal, an uplink control information signal, or any combination thereof.

Aspect 22: The method of any of aspects 20 through 21, wherein transmitting the signal comprises: backscattering the signal based on a power availability of the first network node.

Aspect 23: The method of any of aspects 1 through 22, wherein the first network node is unavailable to communicate information with the second network node during the modified duration of the operational state.

Aspect 24: A method of wireless communications performed by a first network node, comprising: transmitting, for a second network node, timing information corresponding to a timer; modifying, based on an overlap in time of a duration of the timer and a duration of an operational state for the second network node, at least one of the timing information or the duration of the operational state; and communicating with the second network node in accordance with the modified timing information or the modified duration of the operational state.

Aspect 25: The method of aspect 24, further comprising: transmitting, for the second network node, a signal that configures a first delta value for the second network node, wherein modifying at least one of the timing information or the duration of the operational state comprises modifying the duration of the timer or the duration of the operational state based on the first delta value.

Aspect 26: The method of aspect 25, further comprising: receiving, for the second network node, a wake-up signal response that comprises a request for a second delta value for the second network node; and determining the first delta value based on the request.

Aspect 27: The method of any of aspects 24 through 26, wherein the timer comprises a bandwidth part inactivity timer, a bandwidth part switching delay timer, a search space set group switching timer, a secondary cell deactivation timer, a discontinuous reception inactivity timer, a short discontinuous reception timer, or a long discontinuous reception timer.

Aspect 28: The method of any of aspects 24 through 27, further comprising: transmitting, for the second network node, a signal that configures the duration of the operational state for the second network node.

Aspect 29: The method of any of aspects 24 through 28, further comprising: receiving, for the second network node, a signal that comprises a first indication of the duration of the operational state for the second network node, a second indication of the modified duration of the operational state, or both, wherein the communication with the second network node is based on the first indication of the duration of the operational state, the second indication of the modified duration of the operational state, or both.

Aspect 30: A first network node for wireless communication, comprising: a memory; and at least one processor coupled to the memory, wherein the at least one processor is configured to perform a method of any of aspects 1 through 23.

Aspect 31: An apparatus for wireless communications at a first network node, comprising at least one means for performing a method of any of aspects 1 through 23.

Aspect 32: A non-transitory computer-readable medium having code for wireless communication stored thereon that, when executed by a first network node, causes the first network node to perform a method of any of aspects 1 through 23.

Aspect 33: A first network node for wireless communication, comprising: a memory; and at least one processor coupled to the memory, wherein the at least one processor is configured to perform a method of any of aspects 24 through 29.

Aspect 34: An apparatus for wireless communications at a first network node, comprising at least one means for performing a method of any of aspects 24 through 29.

Aspect 35: A non-transitory computer-readable medium having code for wireless communication stored thereon that, when executed by a first network node, causes the first network node to perform a method of any of aspects 24 through 29.

The methods described herein describe possible implementations, and the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B.

Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network node for wireless communication, comprising:
a memory; and
at least one processor coupled to the memory, wherein the at least one processor is configured to:
receive, from a second network node, timing information corresponding to a timer;
modify, based on an overlap in time of a duration of the timer and a duration of an operational state for the first network node, at least one of the timing information or the duration of the operational state; and
communicate with the second network node in accordance with the modified timing information or the modified duration of the operational state.

2. The first network node of claim 1, wherein the at least one processor is further configured to:
increase, based on the modified timing information, the duration of the timer;
decrease, based on the modified timing information, the duration of the timer;
cancel, based on the modified timing information, the duration of the timer; or
pause, based on the modified timing information, the timer.

3. The first network node of claim 1, wherein the timer comprises a bandwidth part inactivity timer, a bandwidth part switching delay timer, a search space set group switching timer, a secondary cell deactivation timer, a discontinuous reception inactivity timer, a short discontinuous reception timer, or a long discontinuous reception timer.

4. The first network node of claim 1, wherein, to modify the duration of the operational state, the at least one processor is configured to:
decrease the duration of the operational state for the first network node.

5. The first network node of claim 1, wherein, to modify the duration of the operational state, the at least one processor is configured to:
cancel the duration of the operational state for the first network node.

6. The first network node of claim 5, wherein the at least one processor is further configured to:
receive, from the second network node, a signal that indicates to cancel the duration of the operational state for the first network node based on the overlap in time of the duration of the timer and the duration of the operational state for the first network node, wherein the duration of the operational state for the first network node is canceled further based on the signal.

7. The first network node of claim 1, wherein the at least one processor is further configured to:
receive, from the second network node, a signal that configures a first delta value for the first network node, wherein, to modify at least one of the timing information or the duration of the operational state, the at least one processor is configured to modify the duration of the timer or the duration of the operational state based on the first delta value.

8. The first network node of claim 7, wherein the signal configures a plurality of delta values comprising at least the first delta value, and the at least one processor is further configured to:
select the first delta value from the plurality of delta values based on the operational state for the first network node, wherein the operational state for the first network node is based on the duration of the operational state comprising an energy harvesting duration for the first network node, based on an energy availability for radio frequency tuning for the first network node, or both.

9. The first network node of claim 7, wherein the signal comprises downlink control information, a medium access control element, a radio resource control signal, or a wake-up signal.

10. The first network node of claim 7, wherein the at least one processor is further configured to:
transmit, to the second network node, a wake-up signal response that comprises a request for a second delta value for the first network node, wherein the signal that configures the first delta value is received based on the request.

11. The first network node of claim 1, wherein the at least one processor is further configured to:
perform an energy harvesting procedure during at least a portion of the modified duration of the operational state.

12. The first network node of claim 11, wherein the modified duration of the operational state comprises a first portion during which a first switch from a communication mode to an energy harvesting mode is configured to occur, a second portion during which the energy harvesting procedure is configured to occur, and a third portion during which a second switch from the energy harvesting mode to the communication mode is configured to occur, wherein the portion of the modified duration of the operational state includes the second portion.

13. The first network node of claim 11, wherein the at least one processor is further configured to:
perform first radio frequency tuning from a first frequency band for communication to a second frequency band for the energy harvesting procedure; and
perform second radio frequency tuning from the second frequency band for the energy harvesting procedure to the first frequency band for the communication, wherein the modified duration of the operational state for the first network node further comprises the first radio frequency tuning and the second radio frequency tuning.

14. The first network node of claim 11, wherein, to modify at least one of the timing information or the duration of the operational state, the at least one processor is configured to:
modify at least one of the timing information or the duration of the operational state based on a type of the energy harvesting procedure, wherein the type of the energy harvesting procedure comprises radio frequency energy harvesting, solar energy harvesting, thermal energy harvesting, vibrational energy harvesting, or laser energy harvesting.

15. The first network node of claim 11, wherein, to modify at least one of the timing information or the duration of the operational state, the at least one processor is configured to:
modify at least one of the timing information or the duration of the operational state based on a capability of the first network node to perform a radio frequency tuning procedure to a new bandwidth part concurrent to the energy harvesting procedure.

16. The first network node of claim 1, wherein the at least one processor is further configured to:
receive, from the second network node, a signal that configures the duration of the operational state for the first network node.

17. The first network node of claim 16, wherein the signal configures a periodicity for a plurality of durations of the operational state for the first network node.

18. The first network node of claim 1, wherein the at least one processor is further configured to:
transmit, to the second network node, a request for a modification to the timing information; and
receive, from the second network node and based on the request, an indication of the modification to the timing information, wherein, to modify the timing information, the at least one processor is configured to modify the timing information based on the indication of the modification to the timing information.

19. The first network node of claim 18, wherein the indication of the modification to the timing information comprises a lookup table, a lookup table index, a codepoint, a value, or any combination thereof.

20. The first network node of claim 1, wherein the at least one processor is further configured to:
transmit, to the second network node, a signal that comprises a first indication of the duration of the operational state for the first network node, a second indication of the modified duration of the operational state, or both, wherein the communication with the second network node is based on the first indication of the duration of the operational state, the second indication of the modified duration of the operational state, or both.

21. The first network node of claim 20, wherein the signal comprises an energy report, a scheduling request, a hybrid automatic repeat request signal, a buffer status report, a random access channel signal, an uplink control information signal, or any combination thereof.

22. The first network node of claim 20, wherein, to transmit the signal, the at least one processor is configured to:
backscatter the signal based on a power availability of the first network node.

23. A first network node for wireless communication, comprising:
a memory; and
at least one processor coupled to the memory, wherein the at least one processor is configured to:
transmit, for a second network node, timing information corresponding to a timer;
modify, based on an overlap in time of a duration of the timer and a duration of an operational state for the second network node, at least one of the timing information or the duration of the operational state; and
communicate with the second network node in accordance with the modified timing information or the modified duration of the operational state.

24. The first network node of claim 23, wherein the at least one processor is further configured to:
transmit, for the second network node, a signal that configures a first delta value for the second network node, wherein, to modify at least one of the timing information or the duration of the operational state, the at least one processor is configured to modify the duration of the timer or the duration of the operational state based on the first delta value.

25. The first network node of claim 24, wherein the at least one processor is further configured to:
receive, for the second network node, a wake-up signal response that comprises a request for a second delta value for the second network node; and
determine the first delta value based on the request.

26. The first network node of claim 23, wherein the timer comprises a bandwidth part inactivity timer, a bandwidth part switching delay timer, a search space set group switching timer, a secondary cell deactivation timer, a discontinuous reception inactivity timer, a short discontinuous reception timer, or a long discontinuous reception timer.

27. The first network node of claim 23, wherein the at least one processor is further configured to:
transmit, for the second network node, a signal that configures the duration of the operational state for the second network node.

28. The first network node of claim 23, wherein the at least one processor is further configured to:
receive, for the second network node, a signal that comprises a first indication of the duration of the operational state for the second network node, a second indication of the modified duration of the operational state, or both, wherein the communication with the second network node is based on the first indication of the duration of the operational state, the second indication of the modified duration of the operational state, or both.

29. A method of wireless communications performed by a first network node, comprising:
receiving, from a second network node, timing information corresponding to a timer;
modifying, based on an overlap in time of a duration of the timer and a duration of an operational state for the first network node, at least one of the timing information or the duration of the operational state; and
communicating with the second network node in accordance with the modified timing information or the modified duration of the operational state.

30. A method of wireless communications performed by a first network node, comprising:
transmitting, for a second network node, timing information corresponding to a timer;
modifying, based on an overlap in time of a duration of the timer and a duration of an operational state for the second network node, at least one of the timing information or the duration of the operational state; and
communicating with the second network node in accordance with the modified timing information or the modified duration of the operational state.
